(19) United States
(12) Patent Application Publication
(10) Pub. No.: US 2020/0076781 A1
(43) Pub. Date: Mar. 5, 2020

(54) Access Manager for Linux Systems

(71) Applicant: IronBench, L.L.C., Urbandale, IA (US)

(72) Inventors: Matthew D. Edwards, Des Moines, IA (US); Brenton Rothchild, Indianola, IA (US); Ben Kiefer, Windsor Heights, IA (US); Nick Christus, Kansas City, MO (US); Brandon Ratzlaff, Olathe, KS (US)

(73) Assignee: IronBench, L.L.C., Urbandale, IA (US)

(21) Appl. No.: 16/552,862

(22) Filed: Aug. 27, 2019

Related U.S. Application Data
(60) Provisional application No. 62/723,923, filed on Aug. 28, 2018.

(51) Int. Cl. H04L 29/06

(52) U.S. Cl. CPC H04L 63/0478; H04L 63/102; H04L 63/20; H04L 63/083; H04L 63/101

(57) ABSTRACT

A system for providing access management of Linux-based system includes an administrative server operatively connected to a network, a plurality of end-user devices operatively connected to the network, at least one data volume associated with each of the plurality of end-user devices, wherein each of the at least one data volume is a Linux volume, and an agent stored on each of the at least one end device for operative communication with software executing on the administrative service. The software on the administrative server is configured to manage the at least one end-user device or the at least one data volume connected to the end-user device.

### RELATED APPLICATIONS

This application claims priority to U.S. Provisional Patent Application No. 62/723,923, filed Aug. 28, 2019 and entitled “Access Manager for Linux Systems”, hereby incorporated by reference in its entirety.

### FIELD OF THE INVENTION

The present invention relates to access management over a cloud-based network. Particularly, the present invention relates to access management for Linux systems over a cloud-based network. More particularly, but not exclusively, the present invention relates to centrally managing, encrypting, monitoring, auditing and reporting behaviors of end-user devices connected to a cloud-based network by an administrative server.

### BACKGROUND

In today's technology environments, whether business, institutional or technical, any work completed using technology begins with an end-user and a computer interfacing with other computers to accomplish tasks. The computers used by end-users are typically not secured in a predictable, repeatable, centrally managed, reportable and auditable method.

Currently there are systems encrypting Linux systems, however there are no systems where one can centrally encrypt, manage, report or audit behaviors of end-users on Linux systems. In today's industry, there exists no predictable, repeatable way Linux devices or disks and drives associated with the devices are encrypted, centrally managed, audited and reported upon for the duration of their life in the technology ecosystem.

Since Linux volumes are not encrypted, centrally managed, reportable and auditable, when a Linux device attaches to a business, technology and/or institutional computer ecosystem, there is no current method available to know if the data is secured or gain access to the data if the physical device or volume is lost or stolen.

Unencrypted, non-centrally/non-institutionally managed Linux volumes attach to what were previously secure networks, oftentimes containing, interacting with and/or downloading confidential and confidential-proprietary information and then leaving the secured premises. Later, if these Linux machines are lost, stolen or otherwise attacked and penetrated, the information and data contained therein lay there unencrypted and publicly exposed for viewing, editing and/or theft.

Therefore, what is needed is a system to centrally manage, encrypt, report and audit devices and disks or drives associated with Linux devices.

### SUMMARY

Therefore, it is a primary object, feature, or advantage of the present invention to improve over the state of the art.

It is another object, feature, or advantage of the present invention to centrally encrypt and manage all Linux devices in a cloud-based network using one system.

It is a still further object, feature, or advantage of the present invention to purposefully rotate encryption keys on a device.

Another object, feature, or advantage is to dynamically report enrollment and encryption status per device or a volume of the device.

Yet another object, feature, or advantage is the ability to remotely access encrypted devices or encrypted volumes on the device.

Yet another object, feature, or advantage is to reset forgotten encryption passwords.

Yet another object, feature, or advantage is to remotely remove a device's access to encrypted volumes or drives.

Yet another object, feature, or advantage is to manage across multiple Linux OS distributions including Ubuntu, Fedora, CentOS and Red Hat Enterprise Linux.

Yet another object, feature, or advantage is the ability to enable information security teams to identify, monitor, manage and audit Linux assets.

Yet another object, feature, or advantage is the ability to report the status of all disks and drives of a device in read-only mode.

Yet another object, feature, or advantage is the ability to evidence NIST, ISO, SOX, PCI-DSS, HIPAA and GDPR compliance.

Yet another object, feature, or advantage is the ability to purposefully rotate passphrase keys used to unlock encrypted volumes of a device.

Yet another object, feature, or advantage is the ability to centrally manage licensing and billing information and make decisions accordingly.

Yet another object, feature, or advantage is the ability to leverage existing enterprise Single Sign-On tools.

Yet another object, feature, or advantage is the ability to leverage existing enterprise Directory Search tools.

Yet another object, feature, or advantage is the ability to purchase the Access Manager System via Credit Card.

Yet another object, feature, or advantage is the ability to purchase the Access Manager via Purchase Order.

Yet another object, feature, or advantage is the ability to purchase the Access Manager via AWS (Amazon Web Services) Marketplace.

Yet another object, feature, or advantage is the ability to report the status of all Linux devices and disks or drives associated with the devices enrolled in the Access Manager System in read-only “Auditor” mode.

Yet another object, feature, or advantage is the ability to report the status of all billing information in “Billing Admin” mode.

Yet another object, feature, or advantage is the ability to integrate the GRUB (Grand Unified Bootloader) to verify LUKS (Linux Unified Key Setup) volume integrity prior to unlocking and mounting volume with UEFI secure boot mechanisms.

Yet another object, feature, or advantage is the ability to take ownership of the TPM (Trusted Platform Module) by the end-user and provide a secure enclave in which to store end-user-specific encryption keys and identity for use with the Access Manager Server.

Yet another object, feature, or advantage is ability to verify boot chain and timing via Platform Configuration Registers (PCRs).

Yet another object, feature, or advantage is the ability to backup and restore the master encryption key for a given volume of a specific device so even if the passphrases are removed the administrator or Access Manager system can restore access to the volume encrypted data.

Yet another object, feature, or advantage is the ability to manage and report upon a cloud provider's encryption technologies for audit purposes.

Yet another object, feature, or advantage is the ability to restrict external devices from being utilized with a device enrolled in the Access Manager system.

Yet another object, feature, or advantage is the ability to report if a given Linux asset has up-to-date Access Management software or needs updates/patches.

Yet another object, feature, or advantage is the ability to provide remote configuration of the audited tool standard on (nearly) all Linux devices.

Yet another object, feature, or advantage is the ability to remotely configure Linux based policy administration systems for audit purposes using multiple configuration tools including Ansible, Salt, Puppet and Chef.

Yet another object, feature, or advantage is the ability to make the end-user software more easily installed and utilized on Linux assets including: a) the ability to install the end-user via Ansible, Salt, Puppet, Chef, etc., b) the ability to utilize pre-built OS software images containing the Access Manager System Component (AMI on AWS (Amazon Machine Images on Amazon Web Services), VMDK/virtual appliance (Virtual Machine Disk) for VMWare, Docker Images, etc.).

One or more of these and/or other objects, features, or advantages of the present invention will become apparent from the specification and claims that follow. No single embodiment need provide every object, feature, or advantage. Different embodiments may have different objects, features, or advantages. Therefore, the present invention is not to be limited to or by any objects, features, or advantages stated herein.

According to one aspect, an Access Manager System may have at least one administrative server operatively connected to a cloud-based network, at least one end-user device operatively connected to a cloud-based network and at least one volume associated with the at least one end-user device. The administrative server is configured to manage the at least one end-user device or the at least one volume and the administrative server is configured to remotely access the at least one end-user device or the volume associated with the at least one end-user device. The volume or end-user device may be encrypted. The administrative server may be configured to assign at least one encryption key to encrypted volumes or encrypted end-user devices. The administrative server may be configured to remotely access the end-user device or the volume using the encryption key. The administrative server may be configured to report on the encryption status of the at least one volume or end-user device. The administrative server may be configured to assign a plurality of encryption keys to the at least one volume or end-user device and rotate the encryption keys. The administrative server may be configured to assign a recovery key enabling the administrative server to remotely access the volume or end-user device.

According to another aspect, an Access Manager System may have one or more of the following features: (a) at least one administrative server operatively connected to a network, (b) at least one end-user device operatively connected to the network, and (c) at least one volume associated with the end-user device, wherein the administrative server configured to manage the at least one end-user device or the volume connected to the end-user device, and wherein the administrative server is configured to remotely access the at least one end-user device or the volume associated with the at least one end-user device.

According to another aspect, a system for providing access management of Linux-based systems includes an administrative server operatively connected to a network, a plurality of end-user devices operatively connected to the network, at least one data volume associated with each of the plurality of end-user devices, wherein each of the at least one data volume is a Linux volume, and an agent stored on each of the at least one end device for operative communication with software executing on the administrative service. The software on the administrative server is configured to manage the at least one end-user device or the at least one data volume connected to the end-user device by (1) maintaining an audit history by periodically updating encryption status of each of the plurality of end-user devices and the at least one data volume associated with each of the plurality of end-user devices, (2) in response to a request, triggering a remote deletion of data on one of the at least one data volume associated with one of the plurality of end-user devices, (3) gaining access to one of the at least one data volume wherein the at least one data volume is encrypted and a password is forgotten by a user, and (4) automatically rotate encryption keys for each of the at least one data volume which is encrypted in order to mitigate risk of compromising security.

According to another aspect, a system for providing access management of Linux-based systems includes an administrative server operatively connected to a network, a plurality of end-user devices operatively connected to the network, and at least one data volume associated with each of the plurality of end-user devices, wherein each of the at least one data volume is an encrypted Linux volume. The system further includes an agent stored on each of the at least one end device for operative communication with software executing on the administrative service. The administrative server is configured to manage the at least one end-user device or the at least one data volume connected to the end-user device by maintaining an audit history by periodically updating encryption status of each of the plurality of end-user devices and the at least one data volume associated with each of the plurality of end-user devices.

### BRIEF DESCRIPTION OF THE DRAWINGS

Illustrated embodiments of the disclosure are described in detail below with reference to the attached drawing figures, which are incorporated by reference herein.

FIG. 1 illustrates one view of the Access Manager System in an embodiment of the present invention;

FIG. 2 illustrates another embodiment of the Access Manager System in the present invention;

FIG. 3 illustrates a pictorial view of starting page for an Access Manager System in an embodiment of the present invention;

FIG. 4 illustrates an Access Manager Server view in an embodiment of the present invention;

FIG. 5 illustrates a directions page for setting up an Access Manager in an embodiment of the present invention;

FIG. 6 illustrates updating the Access Manager System in an embodiment of the present invention;

FIG. 7 illustrates adding an additional administrator server in an embodiment of the present invention;

FIG. 8 illustrates a view of a report generated by the administrative server in an embodiment of the present invention;

FIG. 9 illustrates a list of administrators in an embodiment of the present invention;

FIG. 10 illustrates a list of end-users in an embodiment of the present invention;

FIG. 11 illustrates a view of end-user data stored on the Access Manager system in an embodiment of the present invention;

FIG. 12 illustrates a view of adding an additional end-user device in an embodiment of the present invention;

FIG. 13 illustrates another view of adding an additional end-user device page in embodiments of the present invention;

FIG. 14 illustrates another view of adding an additional end-user device page in embodiments of the present invention;

FIG. 15 illustrates a view of purchasing an additional license for the Access Manager System in an embodiment of the present invention;

FIG. 16 illustrates enrolling a volume on an end-user device in an embodiment of the present invention;

FIG. 17 illustrates automatic enrollment of eligible volumes in an embodiment of the present invention;

FIG. 18 illustrates a view of the Access Manager System Settings in an embodiment of the present invention;

FIG. 19 illustrates another view of an end-user's data stored on the Access Manager System in an embodiment of the present invention;

FIG. 20 illustrates another view of an end-user's data stored on the Access Manager System in an embodiment of the present invention;

FIG. 21 illustrates another view of an end-user's data stored on the Access Manager System in an embodiment of the present invention;

FIG. 22 illustrates another view of an end-user's data stored on the Access Manager System in an embodiment of the present invention;

FIG. 23 illustrates account settings for the Access Manager System in an embodiment of the present invention;

FIG. 24 illustrates a password for a recovery key page in an embodiment of the present invention;

FIG. 25 illustrates a rotating password for a recovery key page in an embodiment of the present invention;

FIG. 26 illustrates the key slots available on a volume in an embodiment of the present invention;

FIG. 27 illustrates view of instituting the Access Manager System in an embodiment of the present invention;

FIG. 28 illustrates view of instituting the Access Manager System in an embodiment of the present invention;

FIG. 29 illustrates a view of instituting the Access Manager System in an embodiment of the present invention;

FIG. 30 illustrates a view of a login screen for accessing the Access Manager System in an embodiment of the present invention;

FIG. 31 illustrates a view of the method of retrieving a forgotten username for the Access Manager System in an embodiment of the present invention;

FIG. 32 illustrates another view of the method of retrieving a forgotten username for the Access Manager System in an embodiment of the present invention;

FIG. 33 illustrates a view of the method of retrieving a forgotten password for the Access Manager System in an embodiment of the present invention;

FIG. 34 illustrates another view of the method of retrieving a forgotten password for the Access Manager System in an embodiment of the present invention;

FIG. 35 illustrates another view of the method of retrieving a forgotten password for the Access Manager System in an embodiment of the present invention;

FIG. 36 illustrates a display on the administrative server for installing the Access Manager System in an embodiment of the present invention in an embodiment of the present invention;

FIGS. 37 A&B illustrate another view of a display on the administrative server for installing the Access Manager System in an embodiment of the present invention in an embodiment of the present invention;

FIG. 38 illustrates a view of a display on the administrative server for purchasing a license for the Access Manager System in an embodiment of the present invention;

FIG. 39 illustrates another view of a display on the administrative server for purchasing a license for the Access Manager System in an embodiment of the present invention;

FIG. 40 illustrates a display of the active licenses for the Access Manager System in an embodiment of the present invention;

FIG. 41 illustrates another display of the display of the active licenses for the Access Manager System in an embodiment of the present invention;

FIG. 42 illustrates another view of a display on the administrative server for purchasing a license for the Access Manager System in an embodiment of the present invention;

FIG. 43 illustrates obtaining a license key on the Access Manager system in an embodiment of the present invention;

FIG. 44 illustrates obtaining a license key on the Access Manager system in an embodiment of the present invention;

FIG. 45 illustrates an agreement an administrator must agree to prior to using the Access Manager system in an embodiment of the present invention;

FIG. 46 illustrates another view of the features of the Access Manager Systems in an embodiment of the present invention;

FIG. 47 illustrates a description of the Access Manager System in an embodiment of the present invention; and

FIGS. 48 A&B illustrate an alternative view of the Access Manager System in an embodiment of the present invention.

FIG. 49 depicts a computing system in accordance with an illustrative embodiment.

Some of the figures include graphical and ornamental elements. It is to be understood the illustrative embodiments contemplate all permutations and combinations of the various graphical elements set forth in the figures thereof.

### DETAILED DESCRIPTION

The following discussion is presented to enable a person skilled in the art to make and use the present teachings. Various modifications to the illustrated embodiments will be clear to those skilled in the art, and the generic principles herein may be applied to other embodiments and applications without departing from the present teachings. Thus, the present teachings are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are discussed in terms of an access manager for Linux systems, it is fully contemplated embodiments of the present invention could be used in most any operating system platform without departing from the spirit of the invention.

The present invention relates generally to systems and methods to centrally identify, encrypt, monitor, audit, report and manage all Linux assets attached to business, technology or institutional ecosystem. More specifically, the present invention relates to a central administrative server to centrally manage and monitor all end-user devices and volumes registered in the system. Furthermore, the administrative server may have the ability to register one or more end-user devices at any time and begin managing, monitoring, auditing and running reports on the one or more end-user device as soon as it is registered with the Access Manager System. The Access Manager system allows administrators working in organizations to protect vital organization information from unauthorized access especially in academia, insurance, finance, healthcare and government organizations.

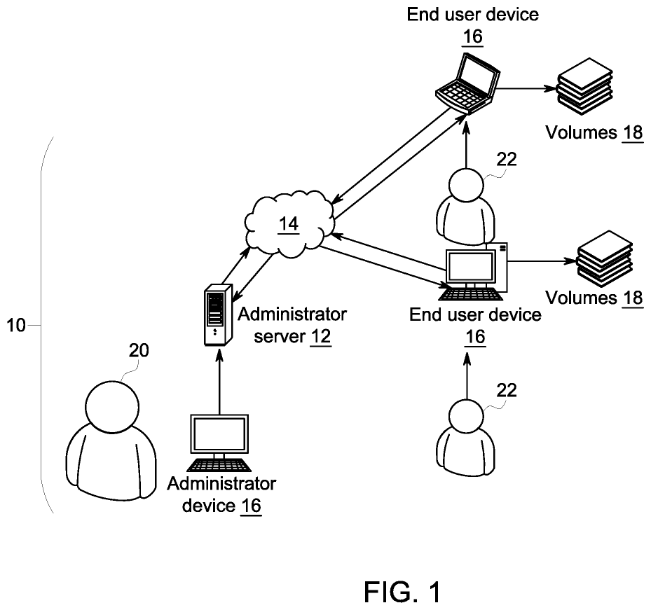

FIG. 1 illustrates one embodiment of the present invention. In FIG. 1, an Access Manager system is 10 is shown which includes an Administrative server 12. The Administrative server 12 may be a web server or other type of server or other computing device which are operatively connected to the cloud-based network 14. As used herein, the “cloud” refers to a network such as a wider area network, such as the Internet. The administrative server allows the administrator to centrally identify, encrypt, monitor, audit, report and manage all Linux assets attached to business, technology or institutional ecosystem.

Various end-user devices 16 such as computers, tablets, smartphones, or other computing devices including workstations within a building may be in communication with the cloud. The end-user devices 16 may have at least one volume (disks or drivers) associated with the end-user device which may be encrypted. Through the administrative server 12, the administrator 20 can manage the encryption of the end-user device(s) 16 or specific disks or drives associated with the specific end-user device(s) 16. An agent may be software installed on each of the end-user device(s) and the Administrative server 12 (or software executing thereon) may then communicate with the agent in order to receive status information on the end-user device(s) 16 and connected data volumes. Each of the devices, systems, and equipment of the Access Manger system 10 may include any number of computing and telecommunications components, devices or elements which may include processors, memories, caches, busses, motherboards, chips, traces, wires, pins, circuits, ports, interfaces, cards, converters, adapters, connections, transceivers, displays, antennas, and other similar components not described herein for purposes of simplicity.

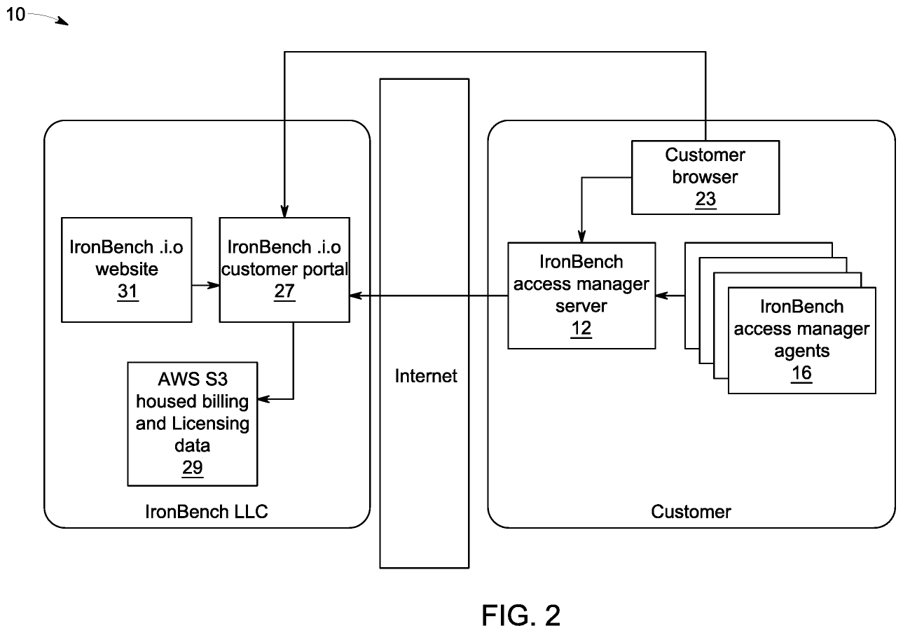

FIG. 2 illustrates an alternative view of the Access Manager system 10. FIG. 2 shows the end-user devices (IronBench Access Manager end-users) in operative communication with the Administrator server 12 (IronBench Access Manager Server) wherein the Administrator server 12 receives end-user data associated with each of the devices 16 through agent software executed on each of the devices 16. The administrator 20 may view end-user details and other information regarding the end-user device(s) 16 or the end-user account on the Access Manager System 10 through a customer browser 23. The Customer portal 27 or web portal may contain billing data and licensing data 29 additionally stored in a database on the administrative server. The administrator may view information regarding the Access Manager system 10 through the customer portal 27 on the Access Manager website (Ironbench.io website) 31.

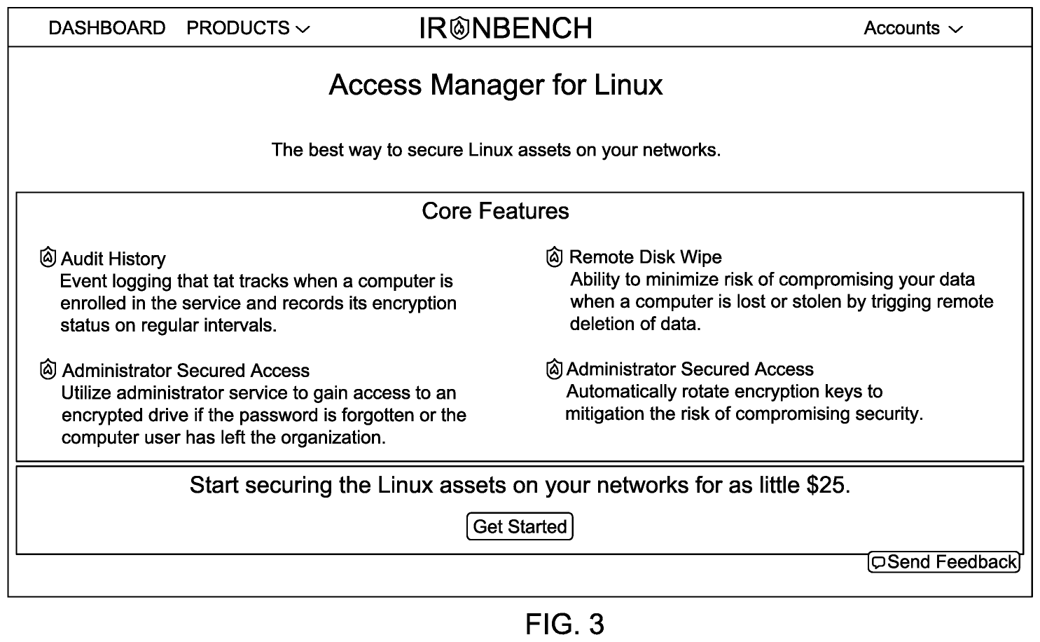

FIG. 3 illustrates an embodiment of the administrative server of the Access Manager System 10. The administrator 20 using the administrative service may be able to audit the end-user devices 16 linked to the Access Manager system 10 to view event logging. Event logging may track when end-user device 16 is registered with the Access Manager System 10 and the encryption status of the end-user device or encrypted volumes (disks and drives) associated with the end-user device(s) 16 at any time at regular intervals allowing the administrator 20 to ensure that the organization's information is protected along with the end-user data associated with the end-user device(s) 16. The administrator 20 may be able to remotely remove access or to remove encryption keys from the end-user device's volume(s) 18 from the administrative server 12 when the end-user device(s) 16 is lost, compromised or stolen. This allows the administrator 20 the ability to protect an organization's information stored on the device(s) 16. The Administrator 20 may also securely access the end-user device(s) 16 if the end-user device 16 or volume 18 is encrypted and the end-user device (16) has been removed from the organization. The administrator 20 may also be able to enroll or assign each end-user device(s) 16 or a specific volume an encryption recovery key to securely access the end-user device(s) 16. The administrator 20 may also need to remotely access the end-user device(s) 16 or volume(s) 18 if the end-user 22 has forgotten an access password or if the end-user device(s) 16 remains with the organization, but the end-user 22 has left. In addition, the administrator 20 may have the ability after accessing the encrypted end-user device to rotate encryption keys, passphrases or passwords associated with the encryption keys to mitigate the risk of comprising the security of the information stored on the encrypted end-user device(s) 16. This allows an administrator 20 of a healthcare organization to protect patient data or in a financial organization to protect client or confidential business data. The administrator 20 may further remotely configure any auditing tools associated with the end-user device(s) 16 or on a volume of the end-user device(s) 16 to protect an organization's information. A report generated by the administrator 20 may show external devices associated with each end-user device(s) 16. The administrator 20 may remotely block access of an external device utilized with an end-user device(s) 16 from accessing a specific encrypted volume to protect confidential information stored in the volume.

The administrator 20 may also audit or view audit reports for all registered end-user devices 16, a specific device 16 or volumes associated with all end-user devices 16 or a specific end-user device 16. The administrator 20 may generate a report on each device(s) 16 compliant with NIST (National Institute of Standards and Technology), ISO SOX (International Organization for Standardization Sarbanes-Oxley), PCI (Payment Card Industry), HIPAA (Health Insurance Portability and Accountability Act) and GDPR (General Data Protection Regulation) or a cloud providers encryption technology. The administrator may also run an audit to track compliance with NIST, ISO SOX, PCI, HIPAA, and GDPR. The reports generated from the audit may be viewed by the administrator 20 in a read only mode or an action mode.

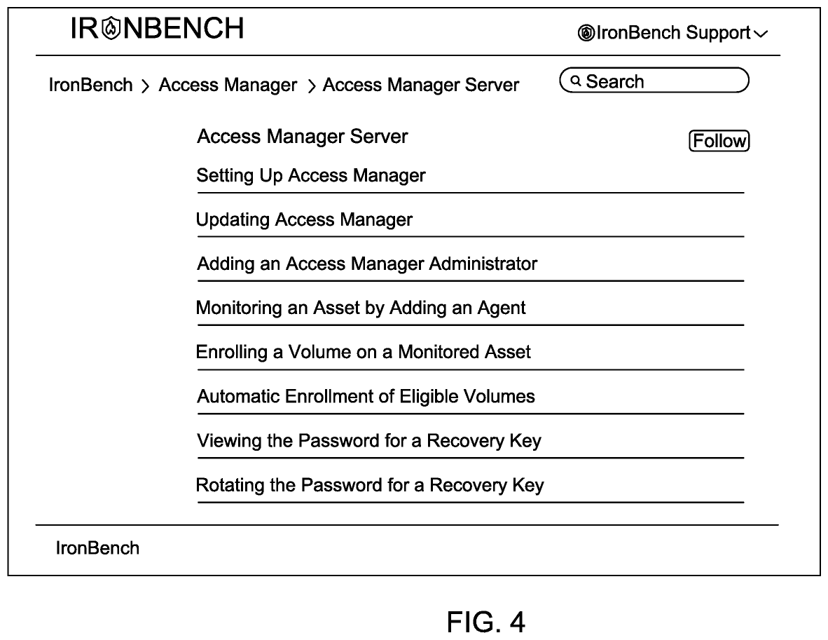

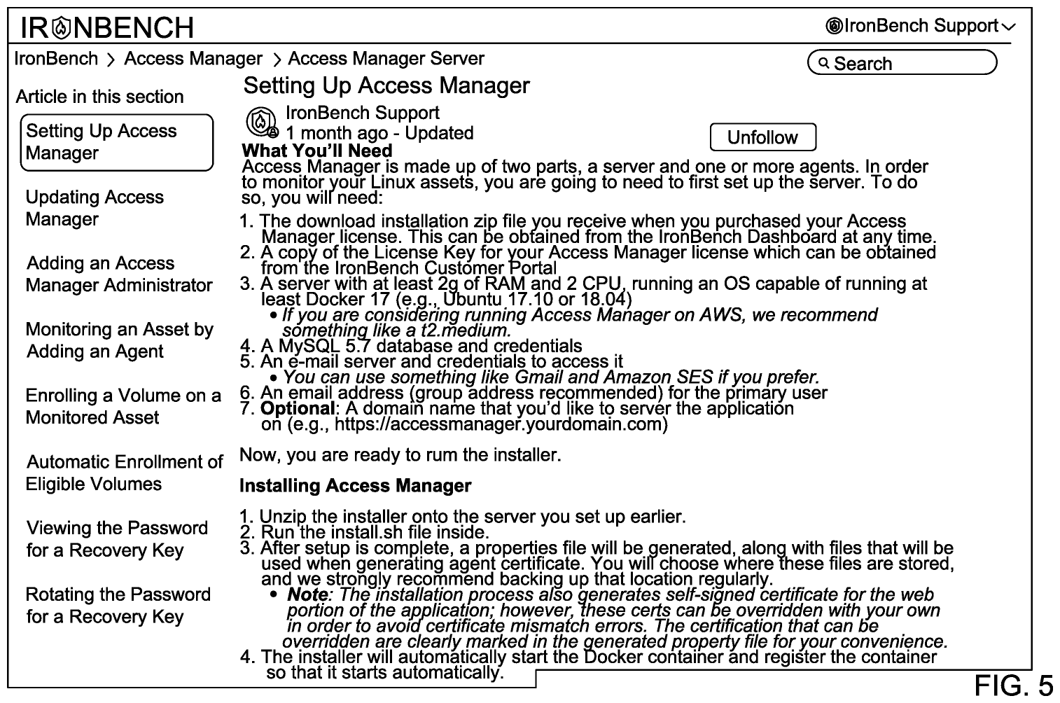

FIG. 4 illustrates the administrator's ability to centrally manage and protect an organization's information security over the cloud network. FIG. 4 shows a display on the web portal server 27, or the administrator's server 12 wherein the administrator may initially set up the Access Manager system 10 to protect the organization's secure information as showing in FIG. 5.

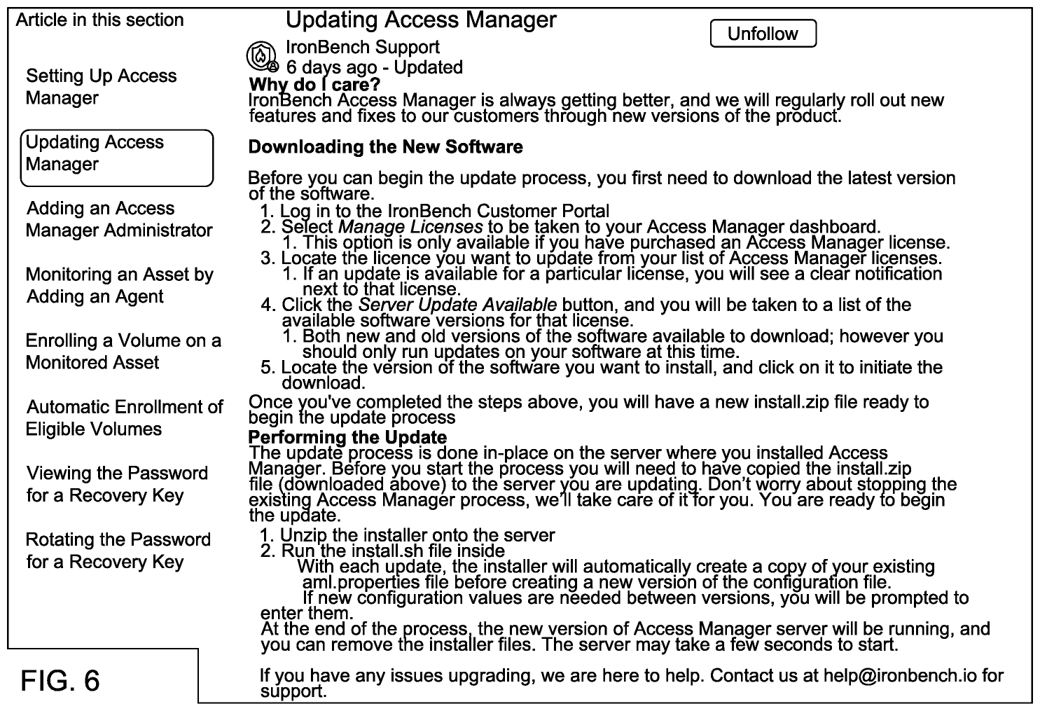

The Administrator 20 may update the Access Manager system 10 to ensure the administrator server 12 is using the best technology to monitor all device(s) 16 attached to the cloud network 14 and using the Access Manager system 10 as shown by FIG. 6.

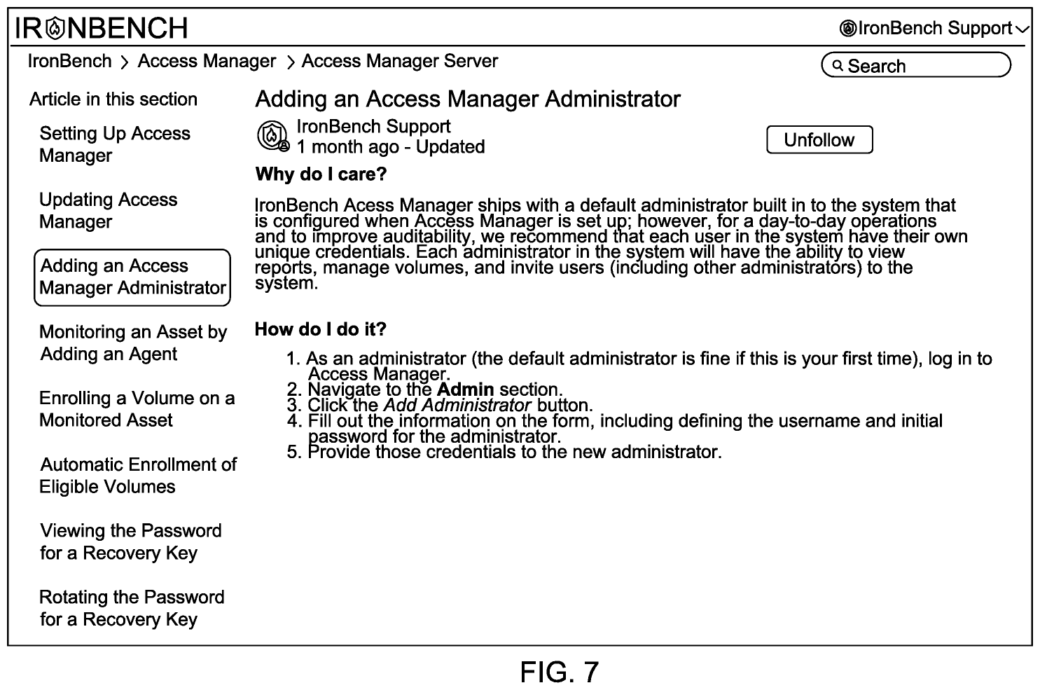

The administrator 20 may also have the option of adding additional Access Manager administrators 20 to centrally manage encrypt, report and audit end-user devices as shown by FIG. 7.

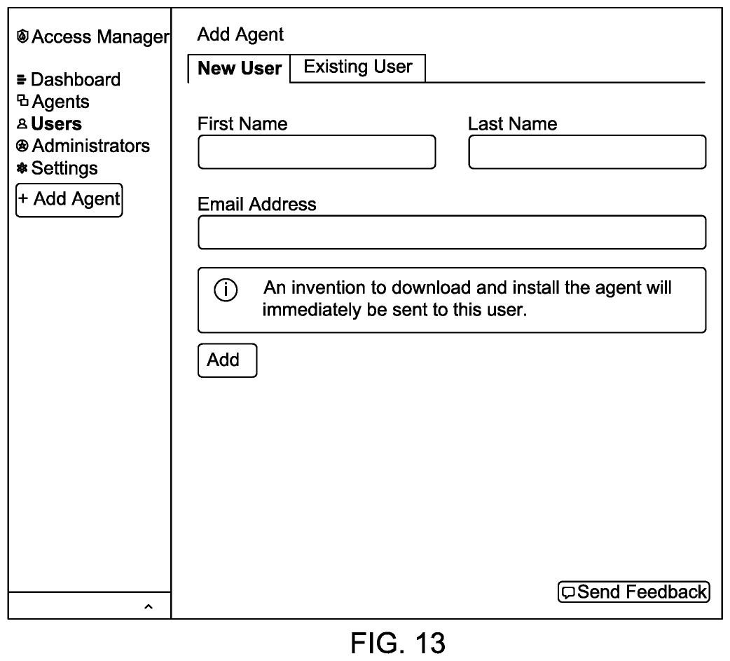

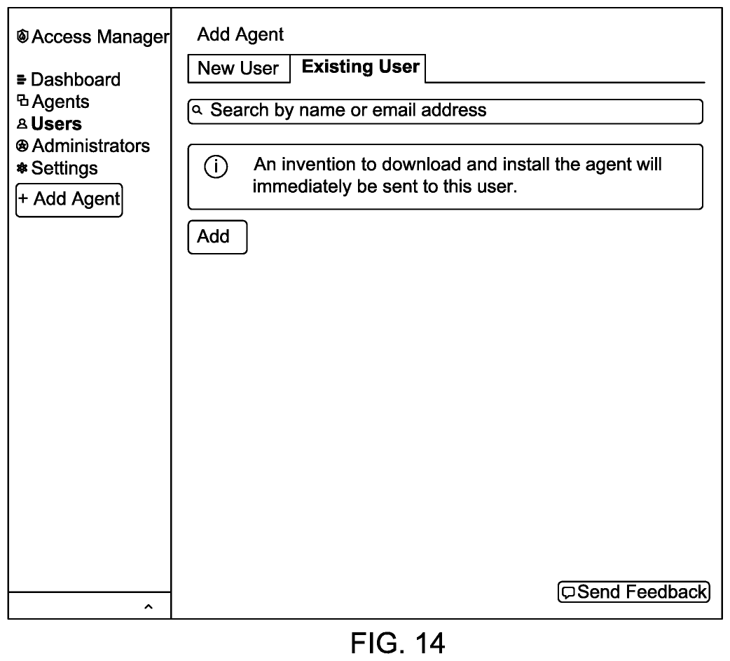

The additional administrators 20 may be beneficial to large organizations where many end-user device(s) 16 connect to the cloud 14 allowing the network to continually monitor all the end-user device(s) 16. The administrator 20 may also monitor new devices 16 or end-users 22 who begin using the system 10 or are continually adding a new end-user 22 as shown by FIG. 13 or by registering a new end-user device 16 of an already registered end-user 22 as shown by FIG. 14.

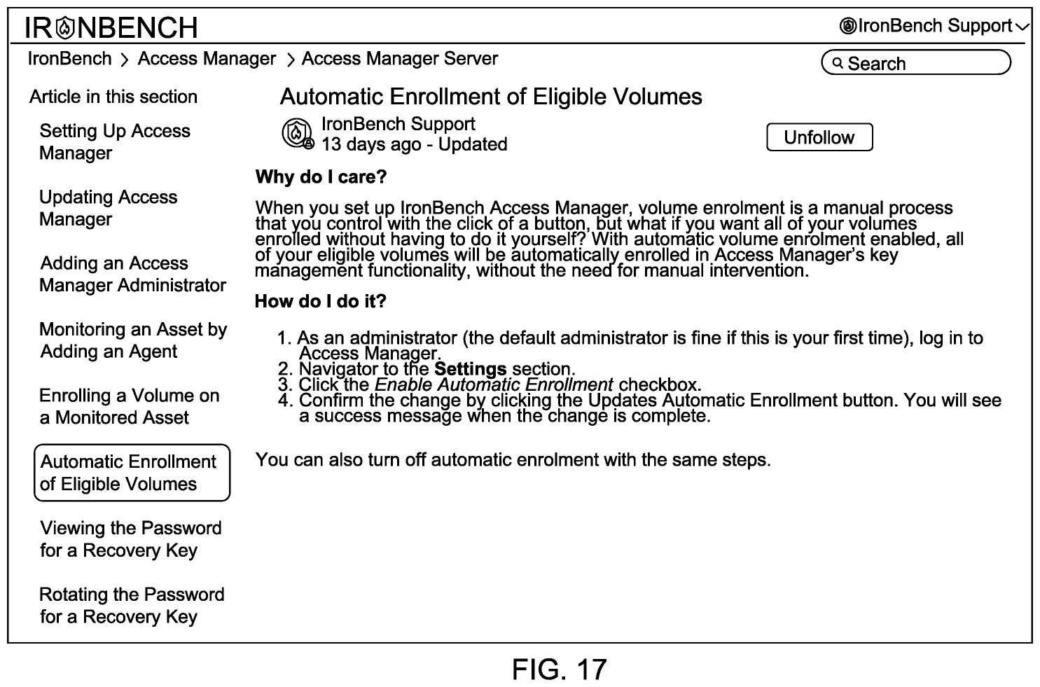

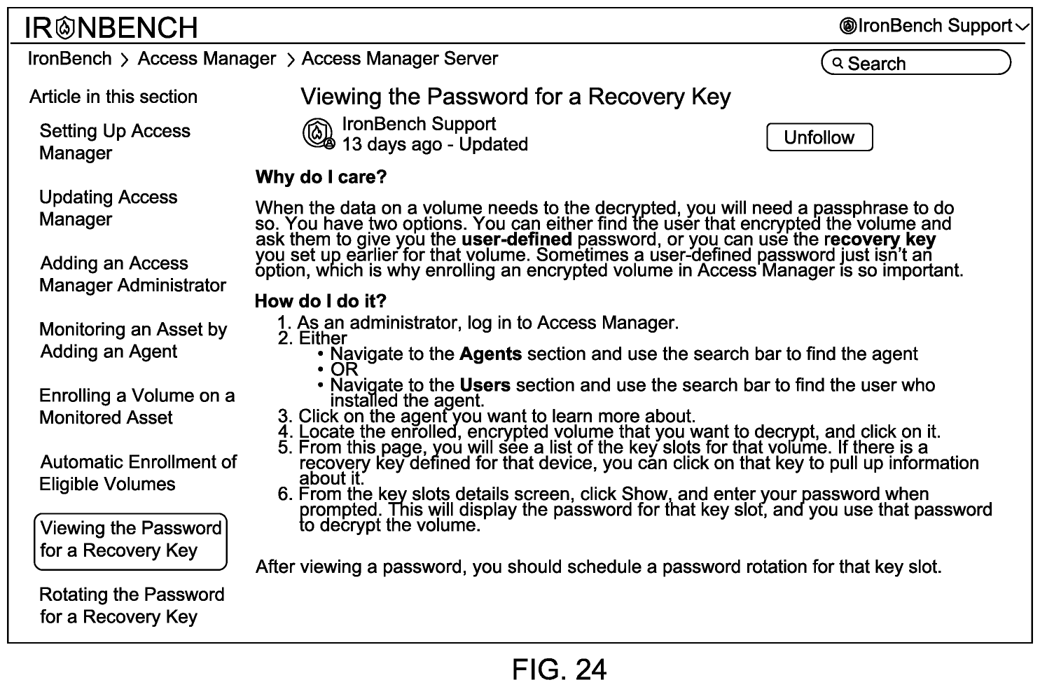

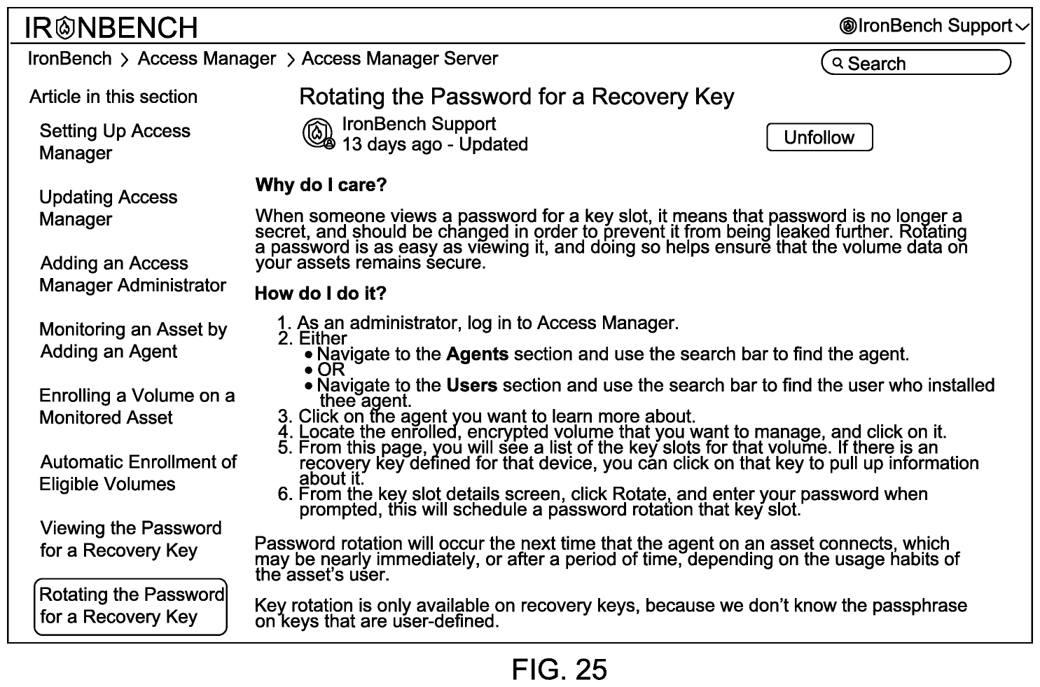

The administrator 20 may also choose to automatically enroll eligible end-user device 16 or volumes 18 in the Access Manager system 10 to ensure the Administrator 20 is centrally managing the security of as many devices 16 attached to the system 10 as possible as shown by FIG. 17. The administrator 20 may also view a password for a recovery key or rotate the password for a recovery key as shown by FIGS. 24 and 25 to ensure end-user device 16 volumes 18 remain encrypted while any of the organizational data is stored on the end-user device 16. The administrator 20 may generate reports on the encryption status of each volume 18 associated with an end-user device 16 or on the end-user device(s) 16. The reports generated by the administrator 20 may be in a read only mode allowing the administrator 20 to audit the volumes or devices. The reports may also be generated in an actionable mode allowing the administrator 20 to perform specific actions remotely such as automatic enrollment, wiping the device while viewing the report. The administrator may also remotely remove an end-user devices access to specific volumes if a password key is removed.

An end-user 22 may only register with the Access Manager system 10 once they receive an invite from the administrator 20. Once the end-user 22 is registered with the Access Manager system 10 the administrator 20 can view reports showing the end-user device 16 information, including whether the end-user device 16 is encrypted or whether the end-user device 16 has any encrypted volumes 18.

FIG. 5 illustrates how an administrator 20 can implement the Access Manager system 10 to ensure the organization's information is secure by centrally managing, encrypting, auditing and running reports on all end-user devices 16 connected to the network 14. The administrator 20 first sets up the administrator server 12 by downloading the Access Manager system 10. The download may be provided by an archive file received when the administrator 20 downloaded the Access Manager system 10 from the web portal or customer portal 27. The archive file may also be obtained at any time from the web portal 27. A licensing key may also be sent to the administrator 20 by email or may be available on the web portal 27 or the license key can be viewed through the customer portal web interface. The administrator 20 must have a server to centrally manage and monitor the end-user devices 16. The server 20 may have at least 2 g of RAM and/or 2 CPUs. The server 12 may also be required to run an OS (operating system) capable of running at least Docker 17 and Ubuntu 17.10 (this list is not mutually exclusive not is this an exhaustive list of possible operating systems).

The administrative server 12 may also be able to centrally manage, encrypt, monitor, report and audit devices running Ubuntu, Debian, Fedora, CentOS and Red Hat Enterprise Linux. The server may also run Access manager 10 on a virtualized or cloud-based hosting environment, such as AWS. The server 12 may also run on a t2 medium or any other server wherein the administrator 20 can centrally manage and monitor the agent devices 16. The administrative server 12 may also have a database requiring specific credentials necessary to access the database. The credentials may be supplied by the administrator's organization or by the web portal. The database may be a MYSQL5.7 database or any other database type wherein the administrator 20 can centrally manage and monitor the end-user devices 16. The administrator 20 may also have an email server requiring specific credentials necessary to access the email server. The email server may be Gmail, Amazon SES or any other email server the organization may use.

The credentials may be supplied by the administrator's organization or by the web portal. The administrator 20 may use an email address specifically associated with the administrator 20 or a group email provided by the organization wherein the administrator 20 or end-users 22 may receive license keys to register end-user devices 16 in Access Manager 10 to begin managing and monitoring the devices 16. The administrator 20 may also choose a domain name where in the end-users 16 may access the Access Manager 10 via the web portal 27.

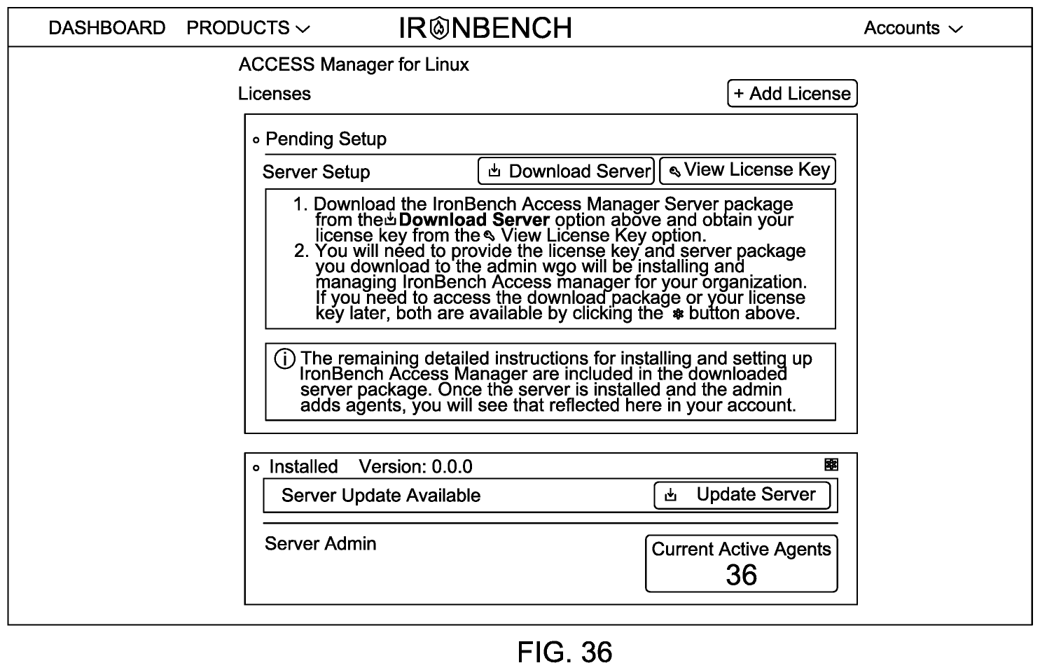

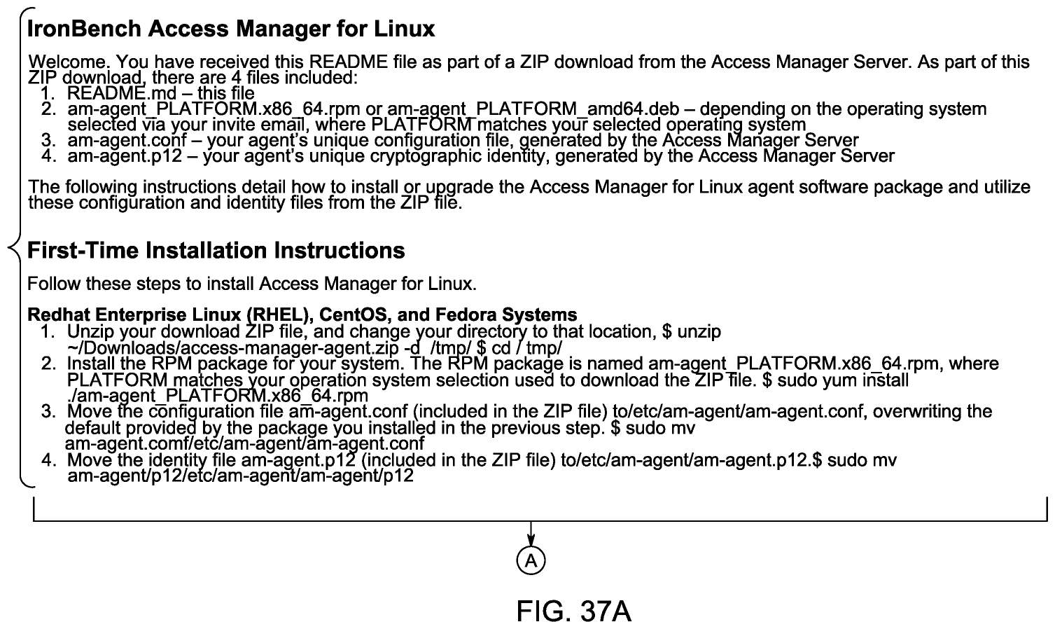

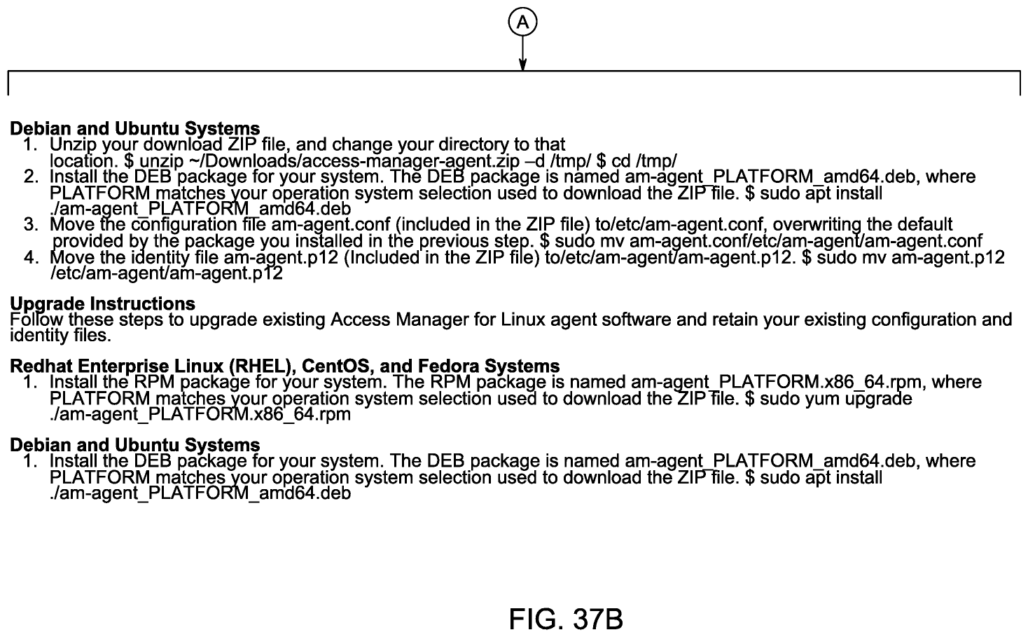

FIG. 5 also provides instructions for installing Access Manager 10 on the localized administrative server 12 to begin monitoring, managing and encrypting all end-user devices 16. The administrator 20 may be required to expand or otherwise unarchive the downloaded archive file and run the install file provided therein. Once set up is complete a properties file may be generated which is used to store any generated certificates, database credentials, email server credentials, etc. The administrator 20 may store the file on the administrative server 12. The install file may automatically install a docker container and register the docker container allowing it to start automatically each time the Administrator 20 uses the server 12 to manage and monitor end-user devices 16. FIGS. 36 and 37 show additional downloading instructions used.

FIG. 6 illustrates how an administrator 20 can update the Access Manager System 10 on the Administrative server 12 to centrally monitor and manage end-user devices 16. The steps may include logging into the web portal 27 from the administrative server 12, selecting manage licenses, and viewing the administrator's dashboard display. The administrator 20 may be able to view a report or generate a report to see how many end-user devices 16 or volumes have up-to-date software or how many end-user devices 16 need updating. The administrator 20 may be required to locate specific licenses the administrator 20 wants to update. The administrator 20 may be notified if an update is available for each specific license. Once the specific license is selected the administrator 20 may next click on the Server Update Available button to see a list of all available updates for the license. Once the administrator 20 locates the specific update, the administrator 20 may click on the update to begin installation. The installation may occur only on the Administrator's server 12.

FIG. 7 illustrates the instructions for selecting or adding an administrator 20. The administrator 20 may add third party administrators 20 such as Infosec (information security) teams to centrally identify, encrypt, manage, monitor, audit and report all registered end-user devices 16. The one or more administrators may access the customer portal and the customer browser to control the purchase of additional licenses and any billing associated with the Access Manager System 10. The original or default administrator 20 may be restricted to only accessing the customer browser and customer portal and the one or more additional administrators 20 may have the ability to access the administrative server 12 to centrally identify, encrypt, manage, monitor, audit and report all enrolled end-user devices 16 and volumes 18.

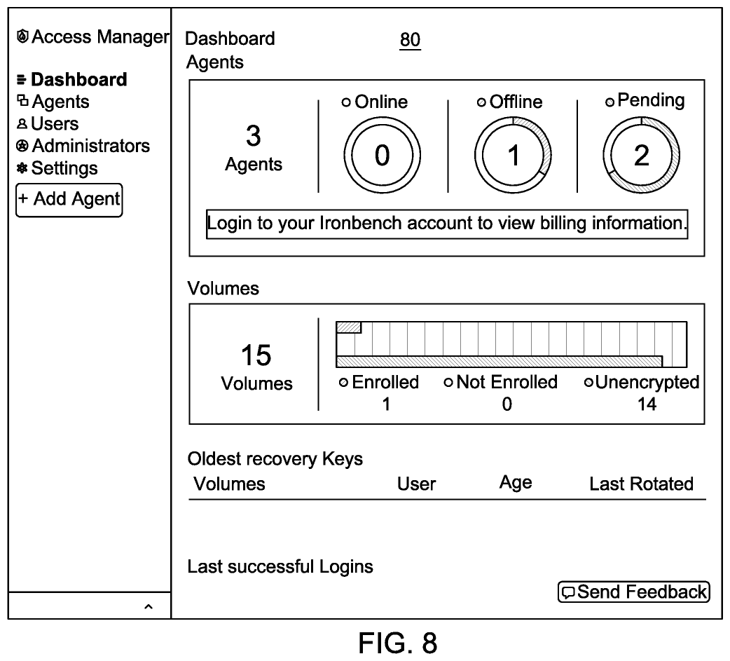

FIG. 8 is one view of the report 80 the administrator 20 receives when centrally monitoring and managing the end-user devices 16. The report 80 may be end-user specific or show a list of all devices associated with the network 14. The report 80 may show the number of end-user devices 16 an end-user 22 has, how many of those end-user devices 16 are enrolled with Access Manager System's recovery key functionality or unenrolled, how many of the end-user devices 16 are encrypted, the status of the end-user devices 16, whether the end-user devices 16 have a recovery key associated with the device 16 and when the recovery key was last rotated, the report may also show a list of administrators 20, a list of end-users 22, specific end-user details, end-user devices 16 with enrollment pending, or another other information the administrator 20 may need to centrally manage and monitor the end-user devices 16 associated with the organization's network 14.

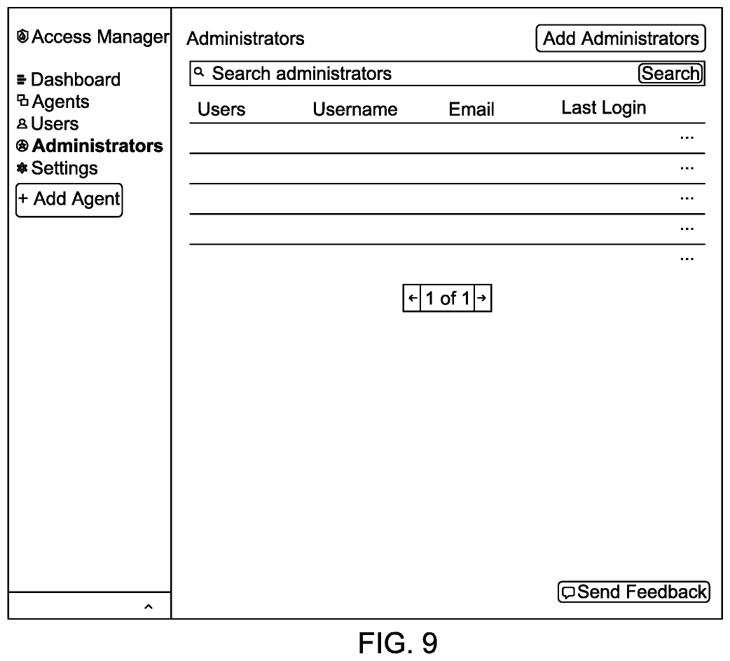

FIG. 9 illustrates another view of the report 80 received by the Administrator 20. The report 80 may display the list of administrators 20. The display may show the end-user name of the administrators 20, the end-user, the email and the last login of each administrator 20. The administrator 20 may have a master encryption key associated with each end-user device 16 allowing the administrator 20 access to each end-user 16 device in the event the administrator 20 feels an organization's information is comprised. Each volume 18 may also have a master encryption key, allowing the administrator 20 access to the specific volumel8 in the event the administrator feels an organization's information has been compromised. This master encryption key may be used or restored if all passwords have been changed or removed. The master encryption key may be stored and backed up on the administrative server 12, where only the administer 20 has access to the encryption key. The administrator's account may store the master encryption key wherein the administrator 20 gives specific additional administrators or Access Manager System customer service access to the master encryption key.

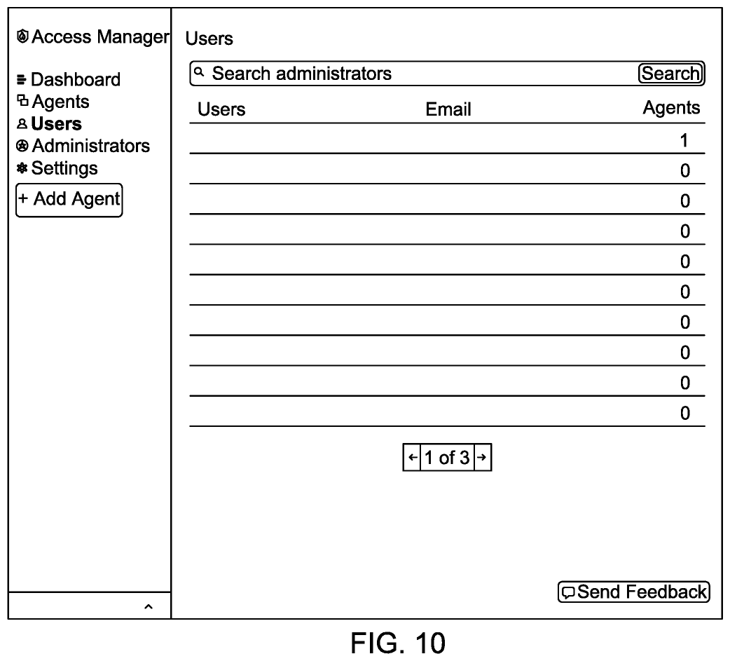

FIG. 10 illustrates the display showing the list of end-users of the Access Manager system 10. The end-users may be administrators 20 or end end-users 22. The display may show whether the end-users have installed the Access Manager software or whether installation is pending. The display may also list how many end-user devices 16 the end-user has.

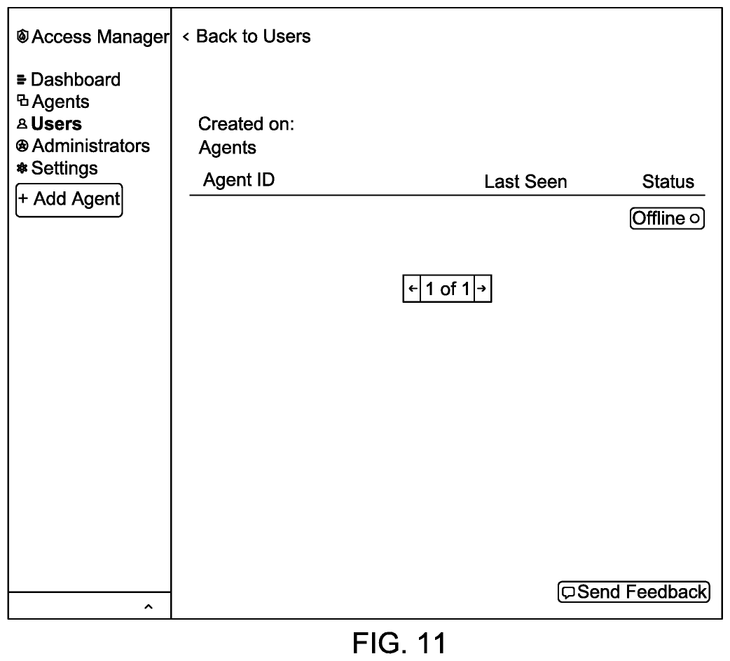

FIG. 11 illustrates the display on the web server of end-user detail for each end-user 22. The details may include the name of the end-user 22, the email address of the end-user, the end-user devices 16 of the end-user, the status of the end-user devices 16, when the end-user devices 16 were last used, and when the end-user first registered with the Access Manager System 10.

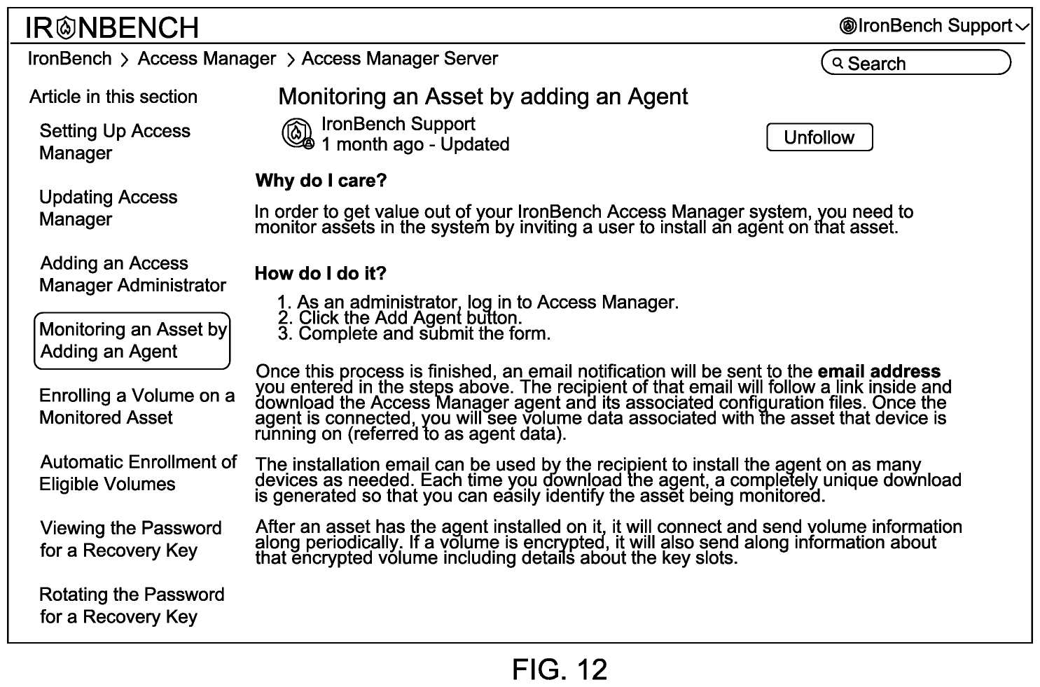

FIG. 12 illustrates how an administrator 20 can obtain the ability to monitor the end-user devices 16 from the administrative server 12. The Administrator 20 from the server 12 may log onto the web portal 27 and select add end-user. Once the administrator 20 completes and submits the form as described in FIGS. 13 and 14 the end-user 22 will be sent an email. The email received by the end-user 22 may be used to register one or more of the end-user's devices 16 with the Access Manager system 10. Every time a new end-user device 16 is registered on the system 10 a unique download may be generated allowing the administrator 20 to easily monitor and identify the end-user device 16. As soon as the end-user 22 is connected to the Access Manager system 10 the administrator 20 can begin centrally managing and monitoring the end-user's one or more end-user devices 16. The administrator 20 may be able to see end-user data associated with the end-user device 16. Once the end-user device 16 is registered in the Access Manager system 10, the end-user device 16 may send end-user data periodically to the administrator server 12. If the end-user device 16 is encrypted the end-user device 16 may send along encryption data, including details regarding the key slots, along with any other end-user data. If an administrator 20 becomes concerned with an end-user's use on the device or a specific volume, the administrator 20 may remove the end-user's access to the organization's information.

FIG. 13 illustrates how an end-user device 16 of a new end-user is registered with Access Manager 10. The administrator 20 or end-user 22 may be required to enter their first and last name along with an email. Once the details are entered the administrator 20 or end-user 22 may then click the add button. After clicking the add button, an invitation will be sent to the administrator 20 or the end-user 22 to download the Access Manager system 10. The end-user 22 or administrator 20may be required to open the link sent by email on the end-user device 16 enrolled in Access Manager system 10 and monitored by the one or more administrators 20. The end-user may be required to download and install an Access Manager System Agent software. The Access Manager System Agent Software may have associated configuration or property files. The administrator 20 may also add a new end-user and at least one end-user device associated with that device using Chef, Puppet, or software images containing the user information or end-user device information such as AMI on AWS, VMDK/virtual appliance for VMWare, Docker image, or any other system or software designed to install software on a device or a volume of the device.

FIG. 14 illustrates how an end-user can register an additional end-user device with Access Manager System 10. An end end-user 22 may choose to register more than one end-user devices 16 such as a secondary laptop, a phone, tablet etc. The end-user 22 may search for his or her end-user profile by entering a name or email address associated with the end-user account. The administrator 20 may use any Directory Search tools available to locate the end-user 22. clicking the add button, an invitation will be sent to download the Access Manager system 10 will be sent to the end-user 22. The end-user 22 may be required to open the link sent by email on the end-user device enrolled in Access Manager system 10 and monitored by the one or more Administrators 20.

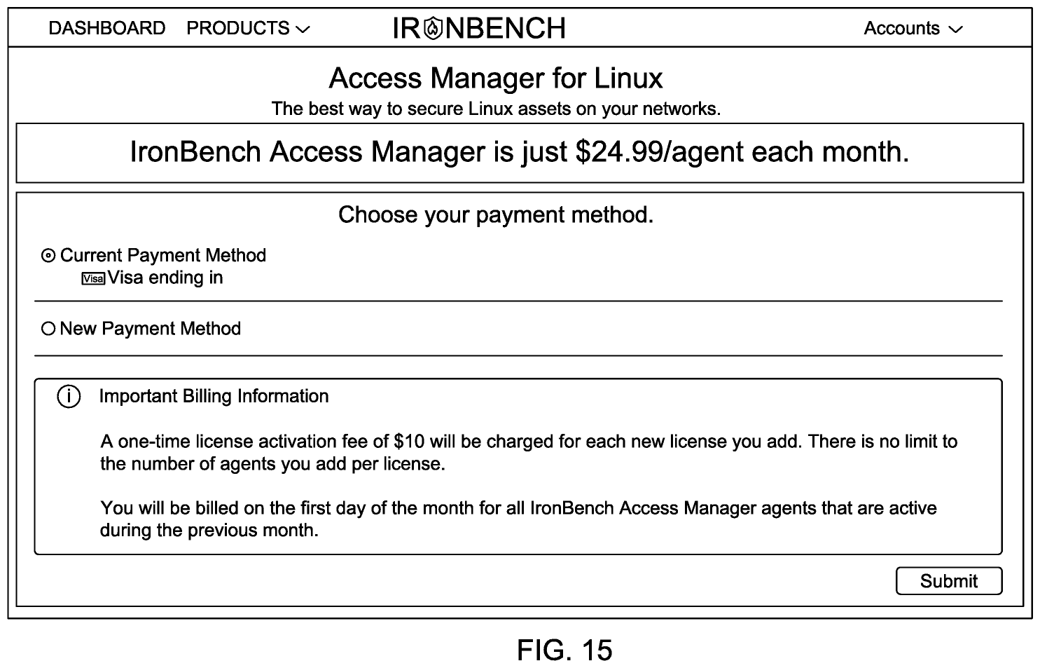

FIG. 15 illustrates an additional way an administrator 20 may add an end-user 22 to the Access Manager System 10. The administrator 20 may purchase additional licenses to the organizations Access Manager system 10. The administrator 20 may purchase licenses or the Access Manager system 10 with a credit card, purchase order, or via the AWS Market place or any additional payment methods. Once the administrator 20 requests a license for instituting the Access Manager system 10 as described in FIG. 5 the administrator 20 can receive the purchased license almost immediately, thereby instituting the Access Manager System 10 on the localized administrative server 12.

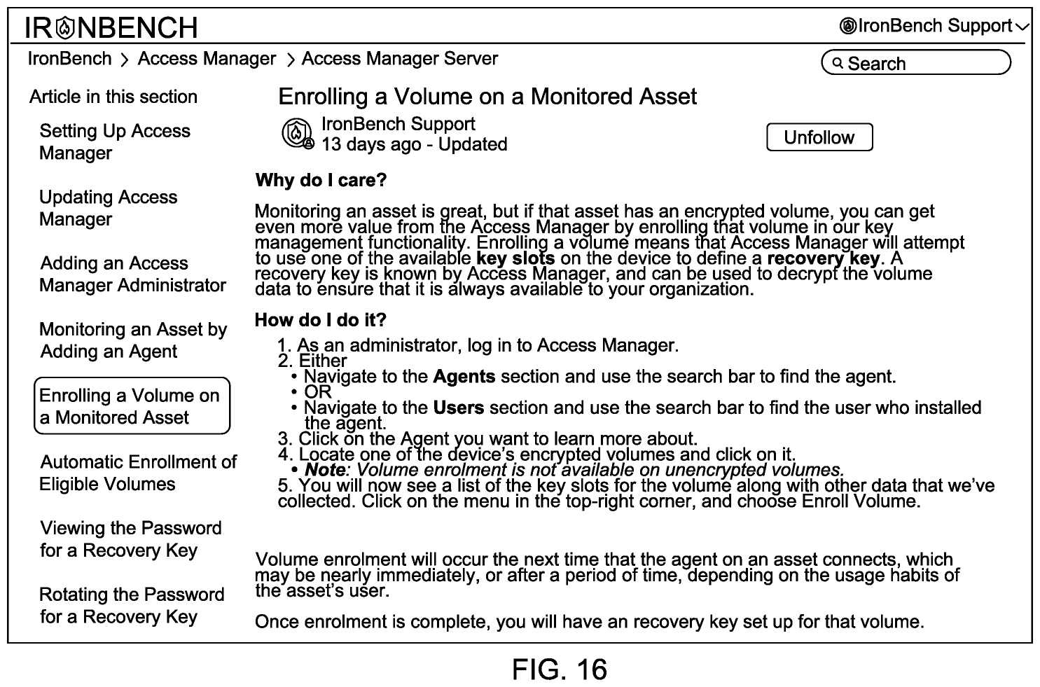

FIG. 16 illustrates how an administrator 20 can monitor end-user devices 16 or volumes 18 enrolled in the Access Manager system 10 recovery key functionality. If the end-user device 16 or volume 18 is encrypted or is an encrypted volume, the administrator 20 can manage the key functionality to define a recovery key for the device in case the end-user 22 is locked out. The key functionality also allows the administrator 20 the ability to decrypt any encrypted volume/encrypted end-user device allowing the administrator 20 access to information stored on the device. FIG. 16 also illustrates instructions for enrolling a volume on an end-user device 16 with the recovery key functionality. The administrator 20 may log on to the web portal from the administrative server 12, locate the end-user 22 or the specific end-user device 16, and review the end-user data associated with the device 16. The administrator 20 may be able to view a list of key slots available for the end-user device along with other data. The administrator 20 may enroll the end-user device 16 to protect the end-user device 16 or a specific volume 18 on the end-user device 16. An academic organization may wish to protect any intellectual property or research data stored on a specific drive on the device and be able to access data in the event the end-user device 16 is lost. Enrollment will be completed the next time the end-user 22 connects to the network 14 with the end-user device 16. Once the enrollment is complete, the administrator 20 may have a recovery key associated with the volume enrolled end-user device 16. The recovery key enables the administrator 20 to access any of the organization's information on the end-user's device 16 from the administrator server. If the administrator 20 works in a governmental organization, the administrator 20 can access any encrypted governmental data stored on the encrypted end-user device 16 or an encrypted volume 18 on the end-user device 16 and the administrator 20 needs to access the data to complete a work product or otherwise. The administrator 20 may also can assign one or more password keys associated to volume or end-user device 16 the end-user may use to access information stored on the device or volume. These password keys may be used to control an end-user's access to a specific volume. If the administrator 20 removes the password key the end-user 22 may no long have access to that specific volume. This allows the administrator to ensure the information remains secure.

An end-user device 16 may use a database to securely store end-user device specific encryption keys and identify the encryption key's use with the Access Manager System 10. The end-user may use a secure enclave to store the database. The end-user device 16 may take ownership of the Trusted Platform Module (TPM) on the end-user device 16 to store the encryption keys and any data associated with the encryption keys. The end-user device 16 may use the Platform Configuration registers on the TPM to verify the boot chain and timing when an administrator 20 remotely accesses the device 16 using a recovery key or a master encryption key to verify the administrator's identity prior to allowing the administrator 20 access to the organization's information. This allows an additional security measure on the end-user's device to protect any encrypted information stored on the device form malicious users.

FIG. 17 illustrates an alternative view for associating a recovery key with an encrypted end-user device 16. This allows the administrator 20 to enroll all eligible encrypted end-user devices 16 with a recovery key without manual intervention as described in FIG. 16, allowing the organization to automatically have access to any organization information stores on the encrypted end-user devices 16 or a specific encrypted volume without having to swift through potentially thousands of devices or disks and drives. To select automatic enrollment, the administration accesses the Access Manager system 10 through the web portal 27 on the administrator server 12 and selects automatic enrollment.

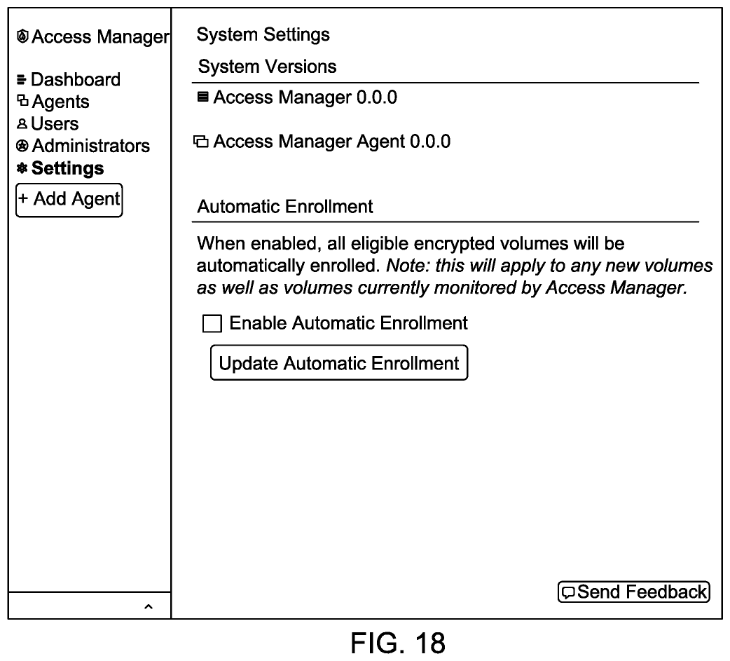

FIG. 18 illustrates certain system settings possibly available to the Administrators 20 such as automatic enrollment in the recovery key functionality management. This includes any new devices along with devices already enrolled by the Access manager system 10.

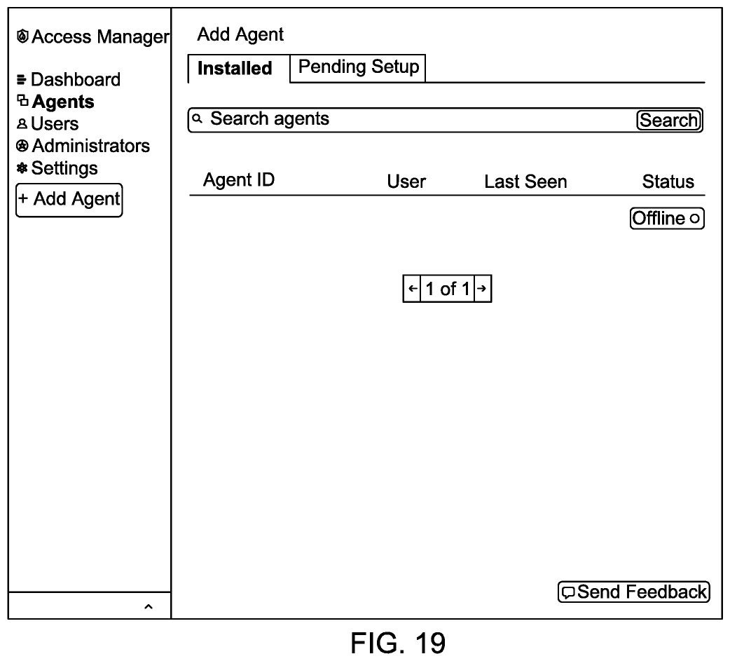

FIG. 19 illustrates how the one or more administrators 20 can view all the end-user devices 16 with Access Manager 10 installed. The administrator 20 may be able to view the unique End-user ID number associated with the end-user 22, the end-user 22 associated with the end-user device 16, when the end-user device 16 last interacted with the cloud 14, and the status of the end-user device 16 (online or offline).

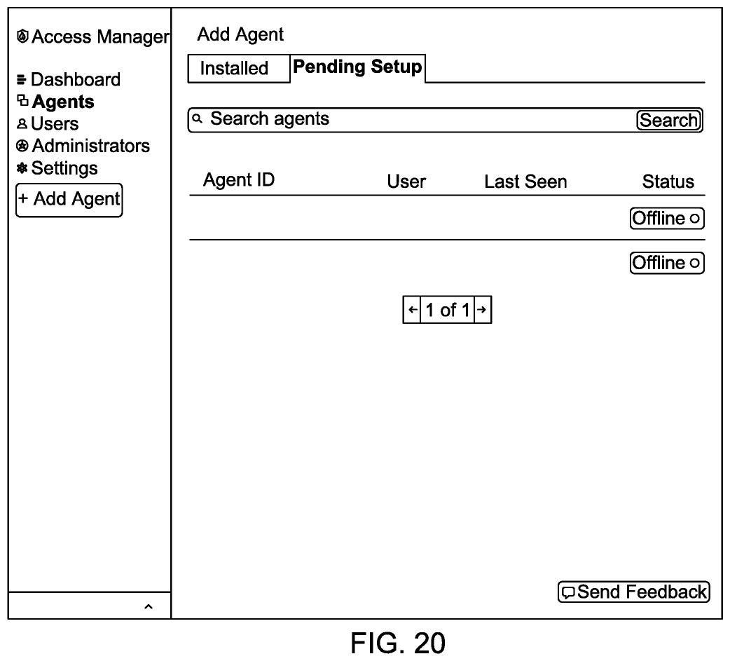

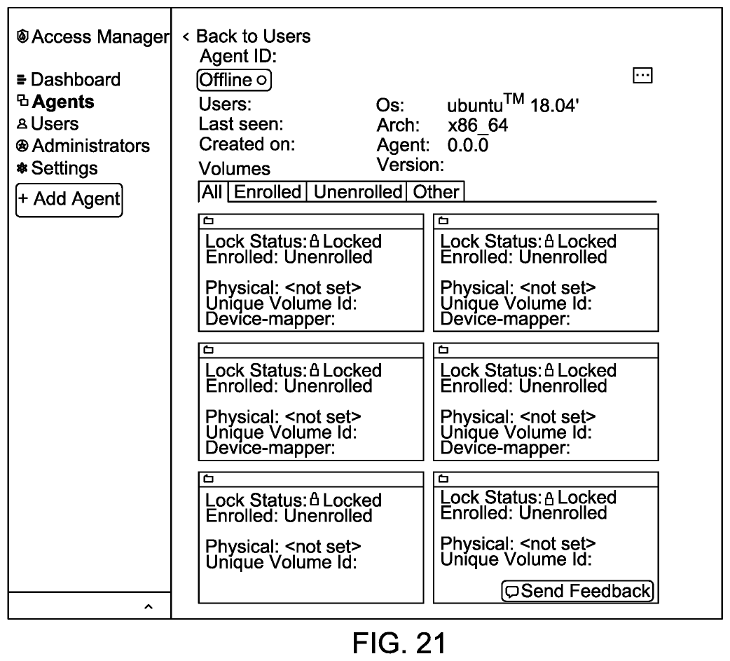

FIG. 20 illustrates how the one or more administrators 20 can view all the end-user devices 16 where installation is pending. The administrator 20 may be able to view the unique End-user ID number associated with the end-user 22, the end-user 22 associated with the end-user device 16, when the end-user device 16 last interacted with the cloud 14, and the status of the end-user 22 (online or offline).

FIG. 21 illustrates a summary of the data the administrator 20 collects from each end-user 22. This data may include the number of end-user devices 16. Which devices 16 are enrolled and unenrolled in Access Manager 10 and any other devices 16 the end-user 22 may have. The details may include the end-user name, the end-user's end-user ID, the status of the end-user 22 whether online or offline, when each end-user device 16 was last interacted with the cloud 14, when the end-user 22 created an end-user profile on the system 10. The details may also include unique volume ID for each volume of the end-user device 16, the name or volume ID of each volume whether each end-user device 16 is locked, whether the volumes associated with the end-user device 16 are locked or encrypted, the physical ID of the volumes, the end-user device name, the number of volumes associated with the end-user device 16, the OS platform of the device 16, the enrollment status of the volumes, an end-user device mapper to locate the volume on the end-user device 16. This allows the administrator 20 to monitor each volume on the device 16 and audit its compliance with the encryption requirements of the organization. The administrator 20 can easily locate a volume if the administrator 20 needs to remotely access the volume.

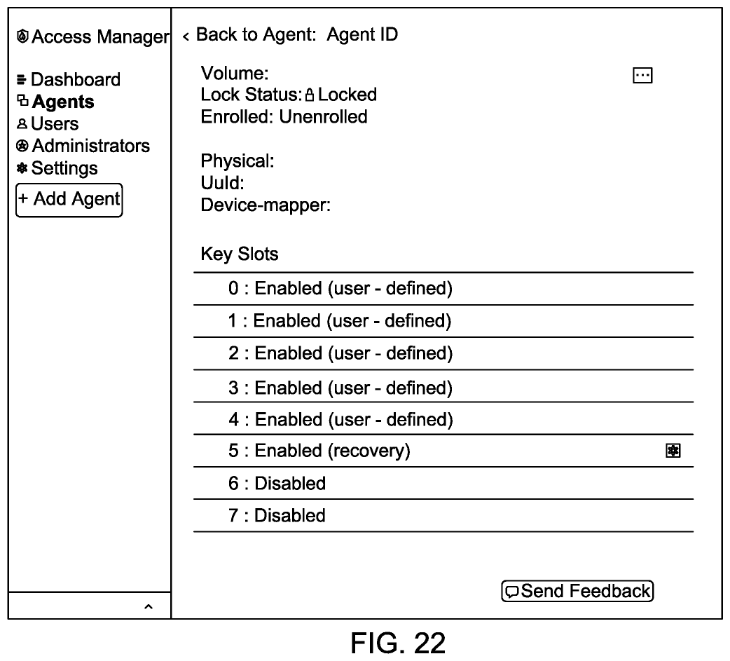

FIG. 22 illustrates the end-user data associated with each volume on the end-user device 16. The administrator 20 can set up numerous encryption keys associated with the volume. The administrator 20 may rotate the encryption keys if the administrator 20 believes the encryption key has been compromised. The administrator 20 may view the number of encryption keys associated with the volume, the lock status of the volume, the enrollment status of the volume, the physical and unique volume ID of the volume, the name of the volume, the device mapper, which encryption keys are enabled, and which key slot is the recovery key. This provides the administrator 20 the information the administrator 20 may require to remotely access the end-user device 16 or the volume remotely from the administrator server 12.

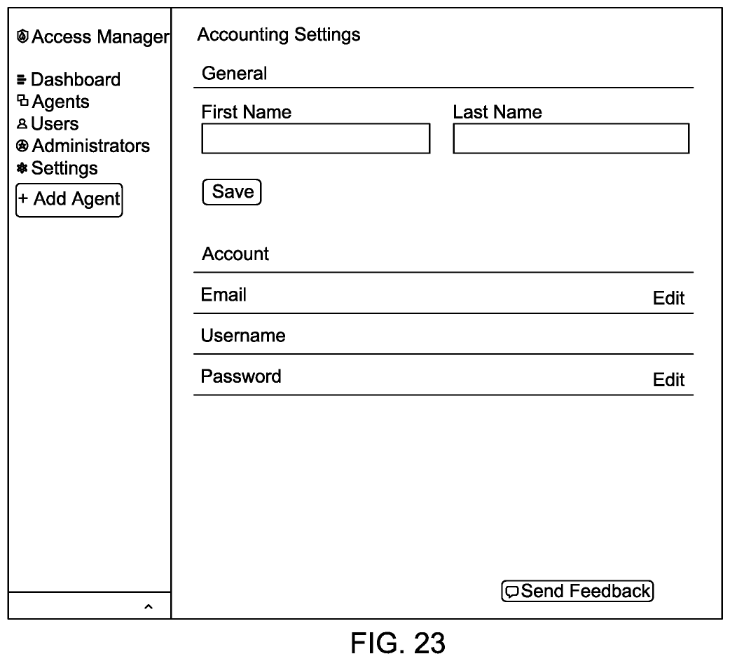

FIG. 23 illustrates how an administrator 20 or end user 22 may update the settings for each administrator 20 or end-user 22 profile. This may include changing the name of the administrator 20 or end-user 22, the email address associated with the administrator account, the username or password. The end-user 22 or administrator 20 may also have the ability to change other details such as the end-user devices 16 enrolled in the system.

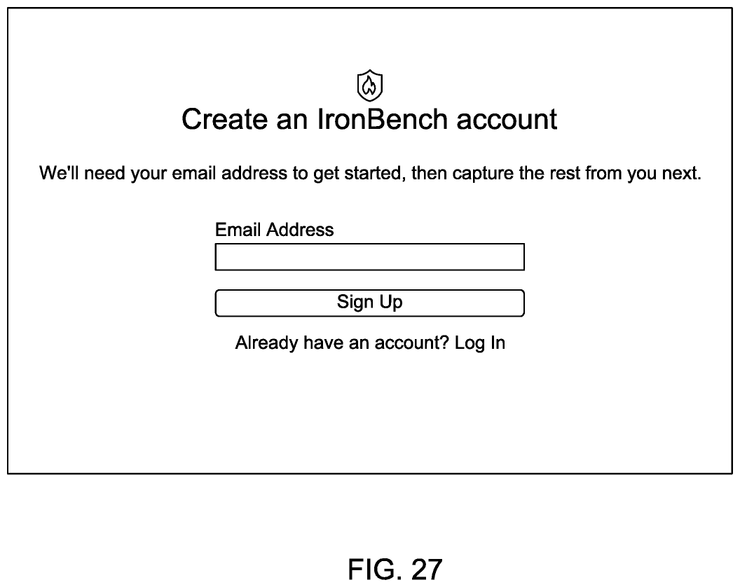

FIG. 24 illustrates how an administrator 20 can remotely decrypt an encrypted end-user device 16 using the recovery key. The administrator 20 may need a password to decrypt the encrypted end-user device 16. The password may be the end-user 22 defined password for the device as shown in FIGS. 27-29 or the administrator 20 may use the recovery key as set up in FIGS. 16 and 17.

FIG. 24 provides instructions for accessing the password of a recovery key. The administrator 20 may locate the encrypted device the administrator 20 wishes to decrypt, view the end-user data associated with the encrypted end-user device which includes the recovery key. The administrator 20 may click on the recovery key and the administrator 20 may view the password for the recovery key. The administrator 20 may then use the password to decrypt the encrypted end-user device 16 remotely, allowing the administrator 20 to access any of the organization's information stored on the device 16. An insurance organization may have the administrator 20 use the administrative server 12 to remove access to an end-user device 16 or a specific volume 18 of the end-user device 16 to protect a client's confidential information. This may be necessary if the encrypted end-user's device 16 is lost or stolen and the administrator 20 is determining whether to remove access to the end-user device 16 or the volume 18 An administrator 20 may verify the integrity of a volume or end-user device 16 prior to unlocking the device 16 and storing any information on the device 16 to the administrative server 12. This allows the administrator 20 to verify any connection with the end-user device 16 is secure, protecting the organizations information. The administrator 20 may use GRUB bootloader and UEFI (Unified Extensible Firmware Interface) secure boot mechanisms to verify the integrity and reboot the end-user device to gain access to the information.

FIG. 25 illustrates how an administrator 20 may change the password remotely for a recovery key once the password is known. This allows the administrator 20 to protect the information stored on the encrypted end-user device 16 or on an encrypted volume 18 of the end-user device 16. The administrator 20 may rotate the password remotely using the administrative server 12. Rotating the password for a recovery key prevents the password from being leaked to additional end-users 22 or non-end-users of the Access Manager system 10 and allows the administrator 20 to protect the organizations information from the Administrative server 12. The administrator 20 accesses the Access Manager system 10 using the administrative server 12 and locates the encrypted end-user device 16 and the end-user data associated with the device 16 including the recovery key. The administrator 20 can choose to rotate the password by selecting the recovery key and clicking rotate, scheduling a password rotation for the recovery key. While rotating the password for the recovery key or when assigning the initial password for a recover key, the administrator 20 may remotely assign multiple passwords for a recovery key. Thereby protecting the end-user 22 and the organization from unauthorized access of the information and end-user data.

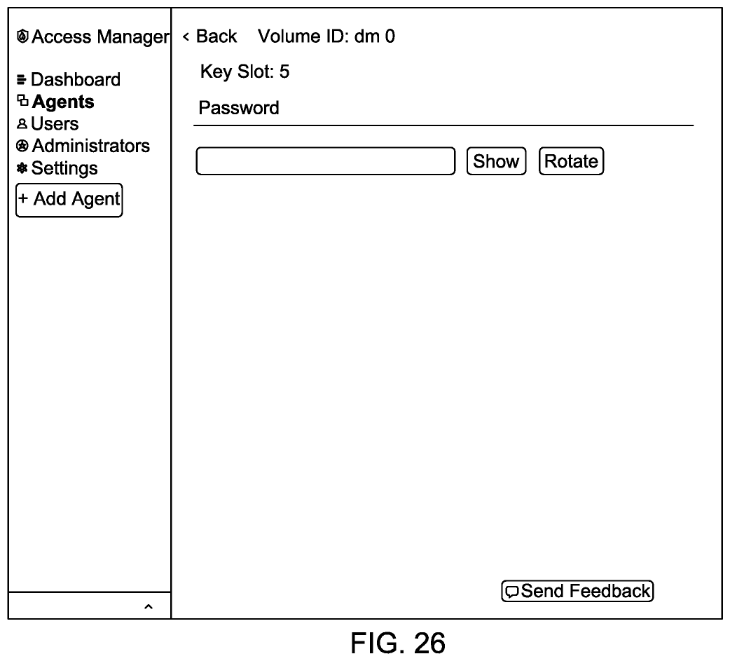

FIG. 26 illustrates how an administrator 20, or an end end-user 22 can rotate an encryption key for an end-user device 16 in the event the administrator 20 needs to rotate the key to gain access to the encrypted end-user device 16. The end-user device 16 is selected from the display, a unique password is entered. The current encryption key slot is listed. The administrator 20 can choose to rotate the encryption key to maintain a secure connection to the network 14 using the administrator server 12 or the web server 27. The administrator 20 may have the ability to set a maximum lifetime for an encryption key. The administrator 20 may change or rotate the encryption key to a new unique value or encryption key after the maximum lifetime of the encryption key has expired.

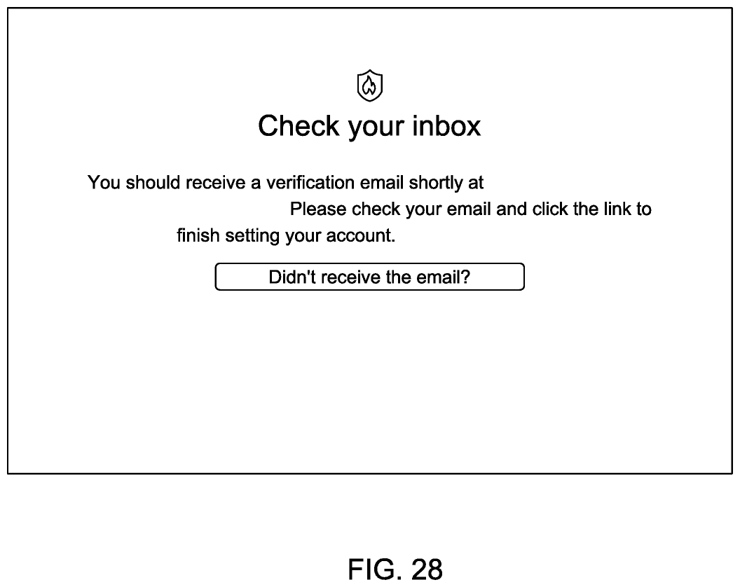

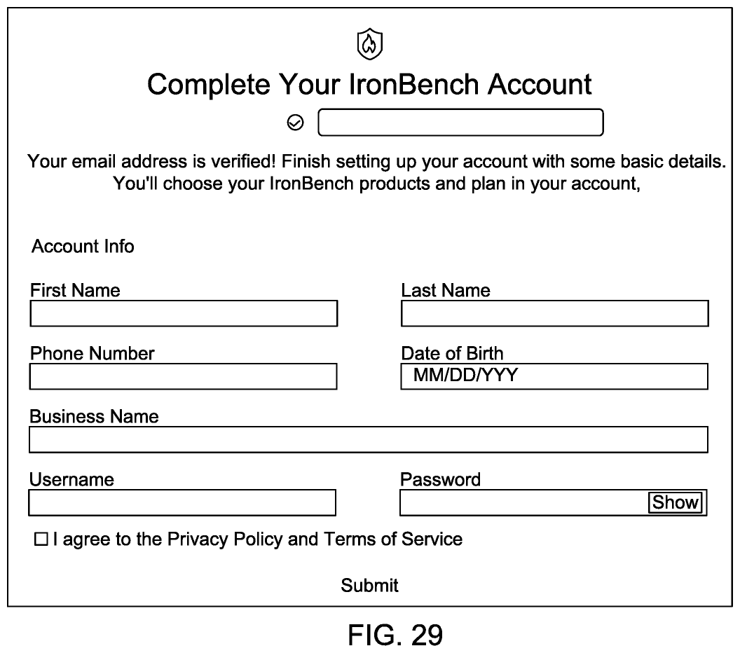

FIGS. 27-29 illustrate how an administrator 20 can institute the Access Manager System 10 for the first time. FIG. 27 shows where an administrator 20 can enter an email address through the web portal server to begin the registration process. Once the email is entered, the administrator may be sent a verification email to complete the registration process as illustrated in FIG. 28. Once the administrator 20 has received the verification email the administrator may be required to enter additional information to complete the registration as shown in FIG. 29 and institute the Access Manager System 10. The additional information may include the administrator's 20 first and last name, a phone number associated with the administrator 20, a birth date, a business name, a username and a password. This information may be used to associate the administrator 20 with an already existing administrator 20 wherein the administrator may receive a licensing key and proceed with registration. The administrator may be directed to set up an administrator server 12 to being centrally protecting and enforcing an organizations information security policy as shown in FIG. 5. Once an administrator is signed up, they can sign on to the Access Manager System 10 at any point. Single Sign-On tools may be used by the end-user or the administrator 20 to sign into the Access Manager System 10.

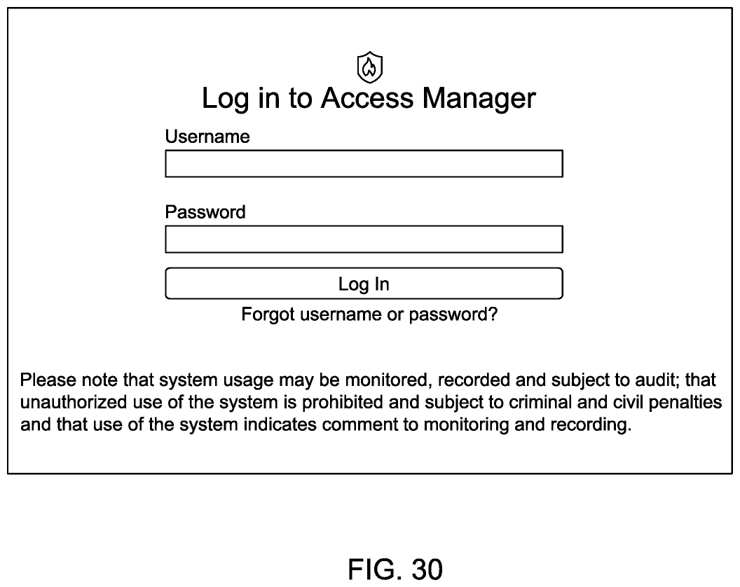

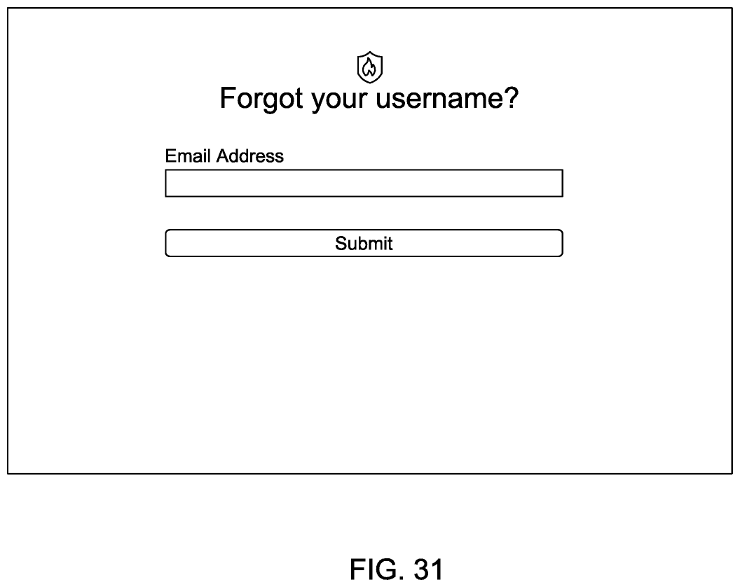

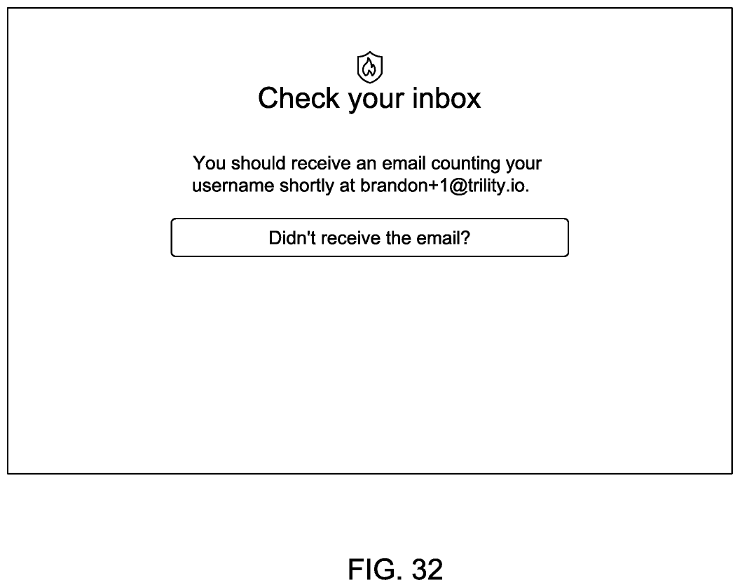

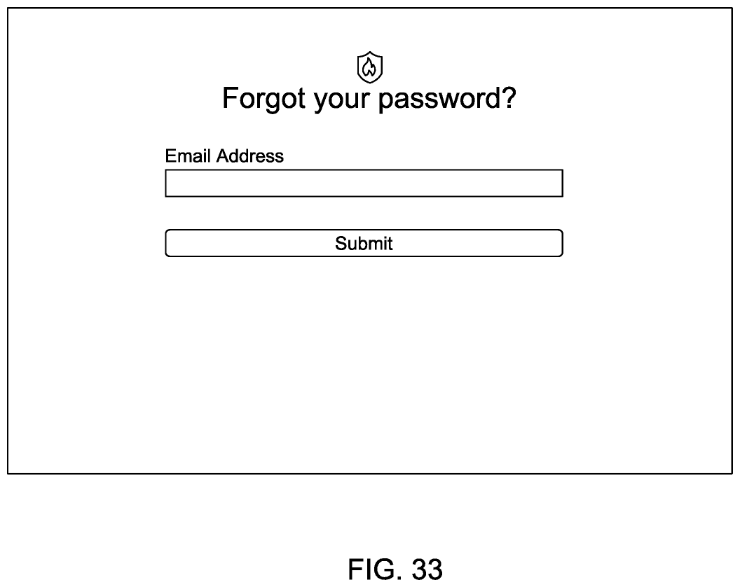

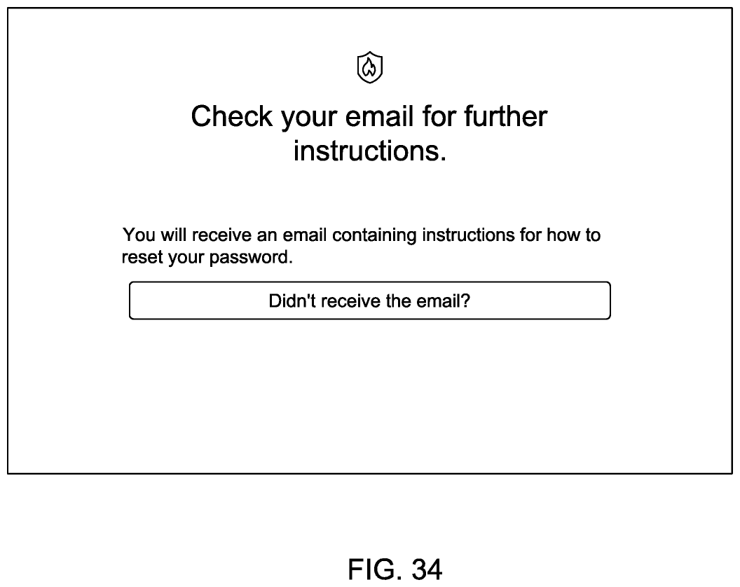

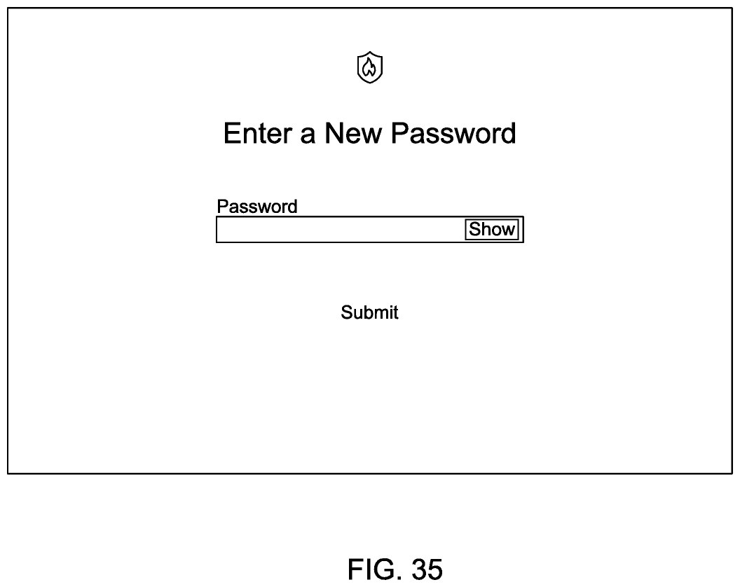

FIGS. 30-35 illustrate how an end-user 22 or administrator 20 may log into Access manager 10. FIG. 30 illustrates the initial log in page. The end-user 22 or administrator 20 may be able to recover the username associated with the account or rest a password. The administrator 20 may recover a password remotely or from a database stored on the administrative server 12. When the end-user 22 is recovering a username associated with the account the end-user 22 may be required to enter an email address associated with the account as shown in FIG. 31. The end-user 22 will be sent an email containing the end-user name as shown in FIG. 32. If the end-user 22 is recovering a password associated with the account, the end-user 22 may be required to enter a username associated with the account to recover the password or another identifier such as an email address or phone number associated with the account as shown by FIG. 33. Once the identifier is entered, an email will be sent to the end-user 22 or administrator 20 containing instructions to reset the password as shown by FIG. 34. The link to reset the password may expire. The end-user 22 or administrator 20 may be required to enter a new password as shown by FIG. 35.

FIG. 36 illustrates an addition report available to the administrator 20 on the administrator server 12 showing the administrative server 12 needs to be updated to generate the most up to date-reports.

FIG. 37 illustrate additional instructions for setting up the administrative server 12.

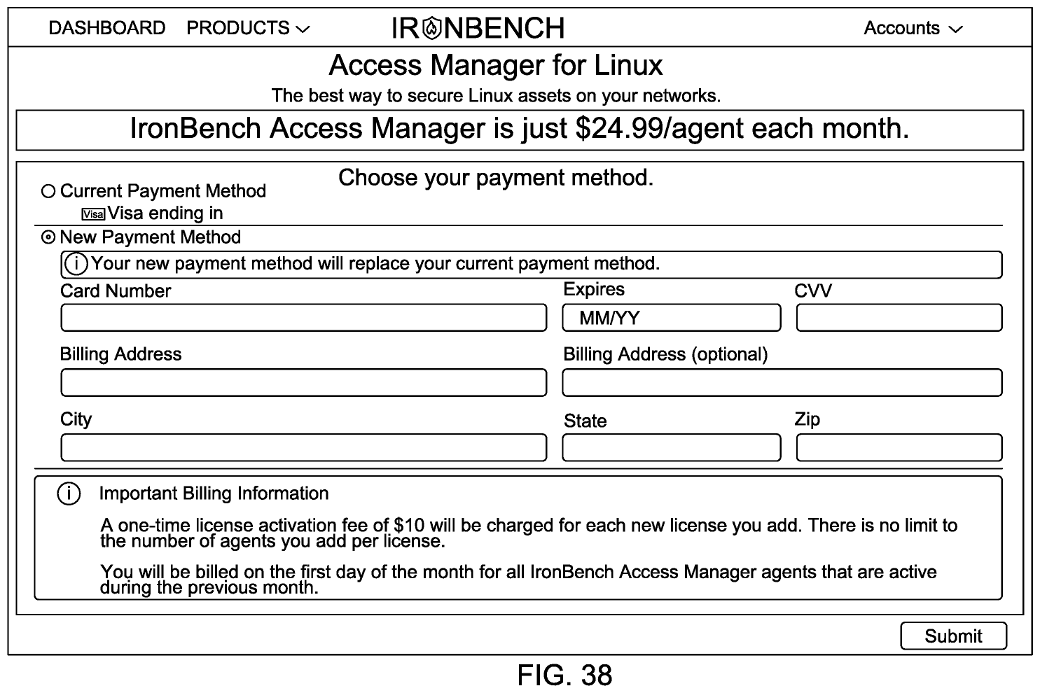

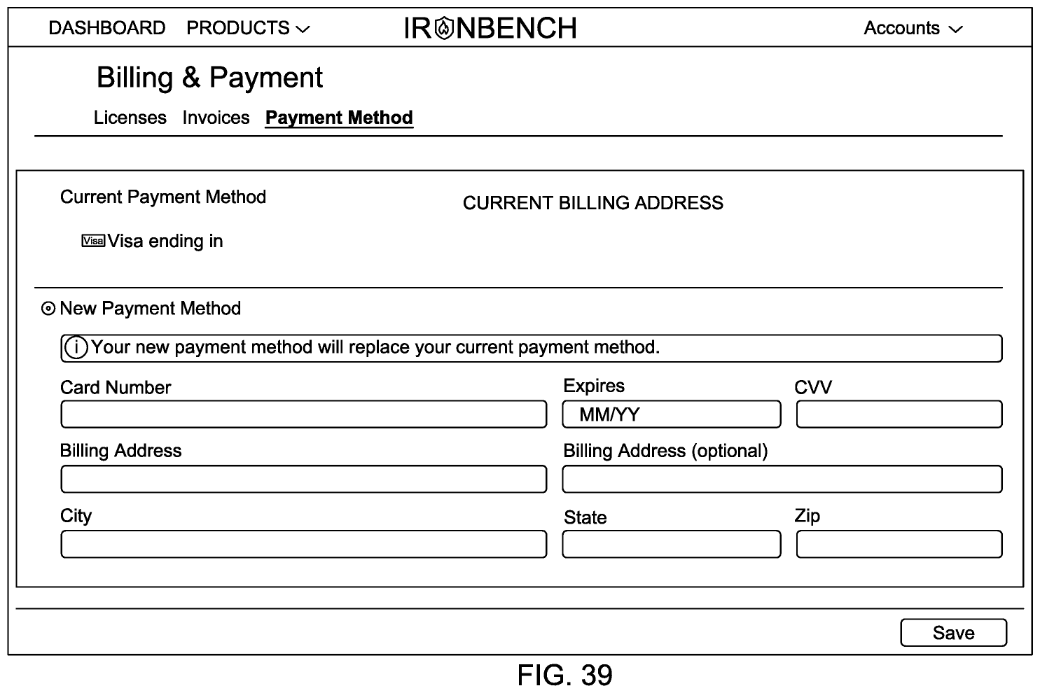

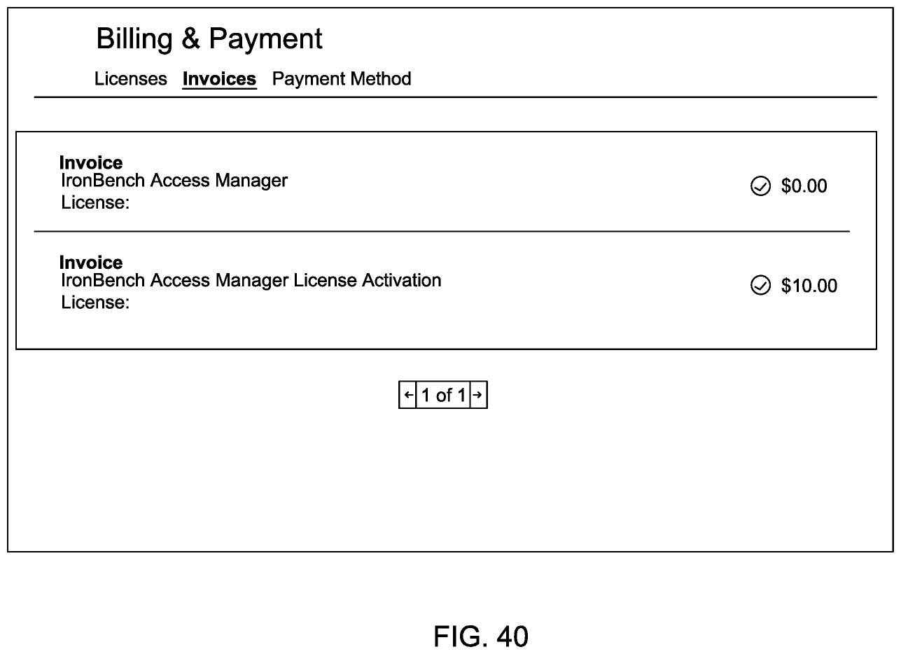

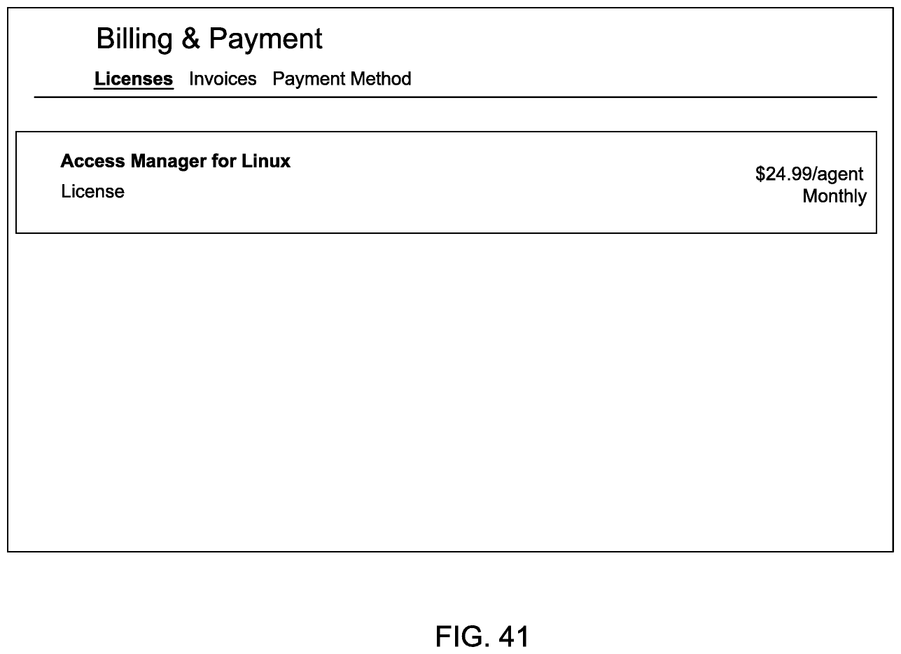

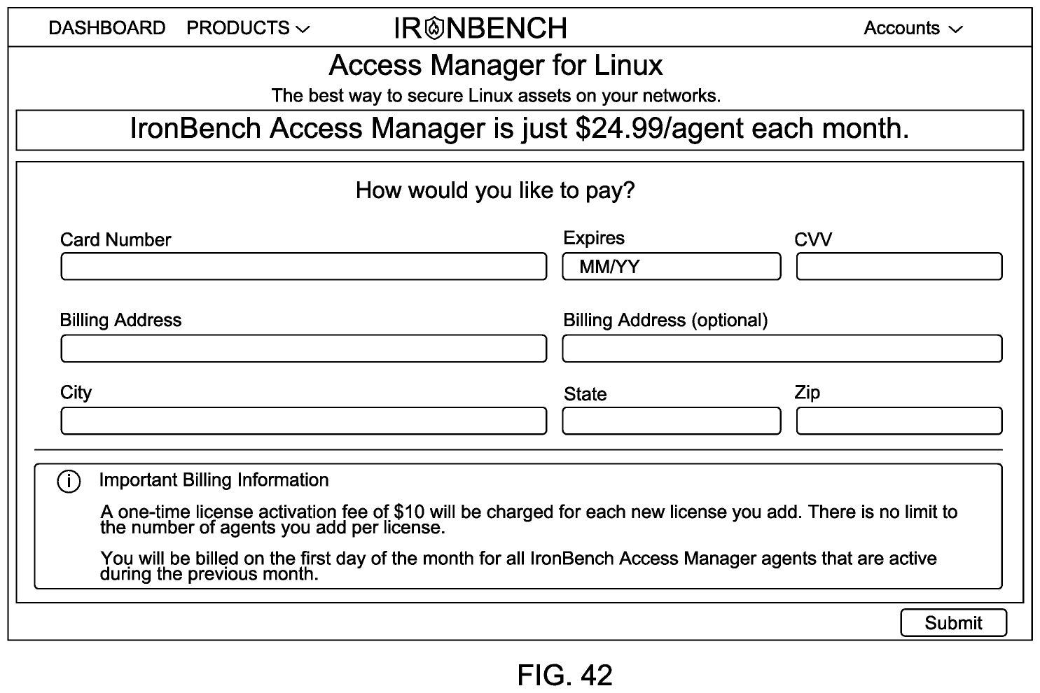

FIGS. 38-42 illustrate additional ways an administrator 20 may pay for additional license keys. The administrator 20 can change the payment method for purchasing licenses at any time as shown by FIGS. 38, 39 and 41. The administrator 20 can view all the licenses associated with the organizations Access Manager System 10 at any time as shown by FIG. 42. The administrator 20 may also view the length of time the license has been associated with the Access Manager System 10 as shown by FIG. 41. The administrator 20 may view a report on the status of all billing information related to any purchased licenses or the Access Manager System 10. The administrator 20 may centrally manage all the billing information and licensing information to make decisions regarding how many additional licenses to purchase, or Access Manager System decisions.

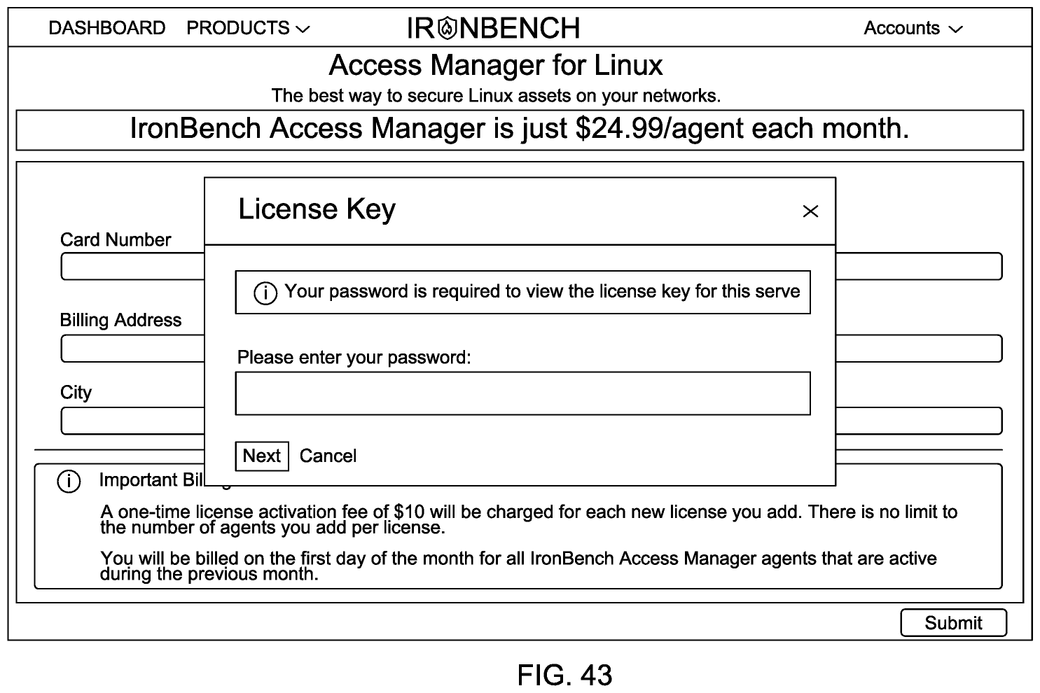

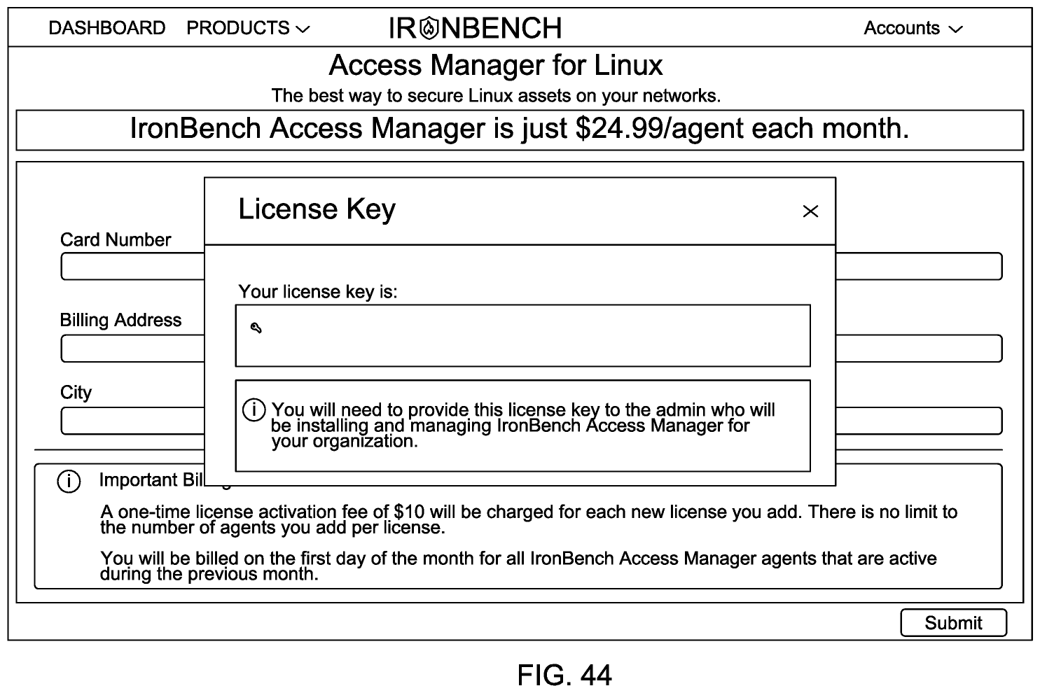

FIGS. 43 and 44 illustrate how an administrator 20 can view the license key associated with the Access Manager System 10. The administrative server 12 will download the software through the webserver. The administrator 20 may click on the link. The administrator 20 may be required to enter an end-user name and password. The administrator 20 will receive a license key as shown in FIG. 43 and FIG. 44. The license key is only visible when a password is entered. The license key which will may be stored in the cloud 14 and sent to the localized administrative server 12. The administrator 20may then install the encryption software on the localized administrative server or send the software package to another administrator 20 to install on a different localized administrative server 12. Once the administrative server 12 has received the encryption pack, and installation is complete administrative server 12 can begin managing, encrypting, monitoring, auditing and reporting on end-user devices registered with the Access Manager System 10. A license may only be visible to the administrators 20.

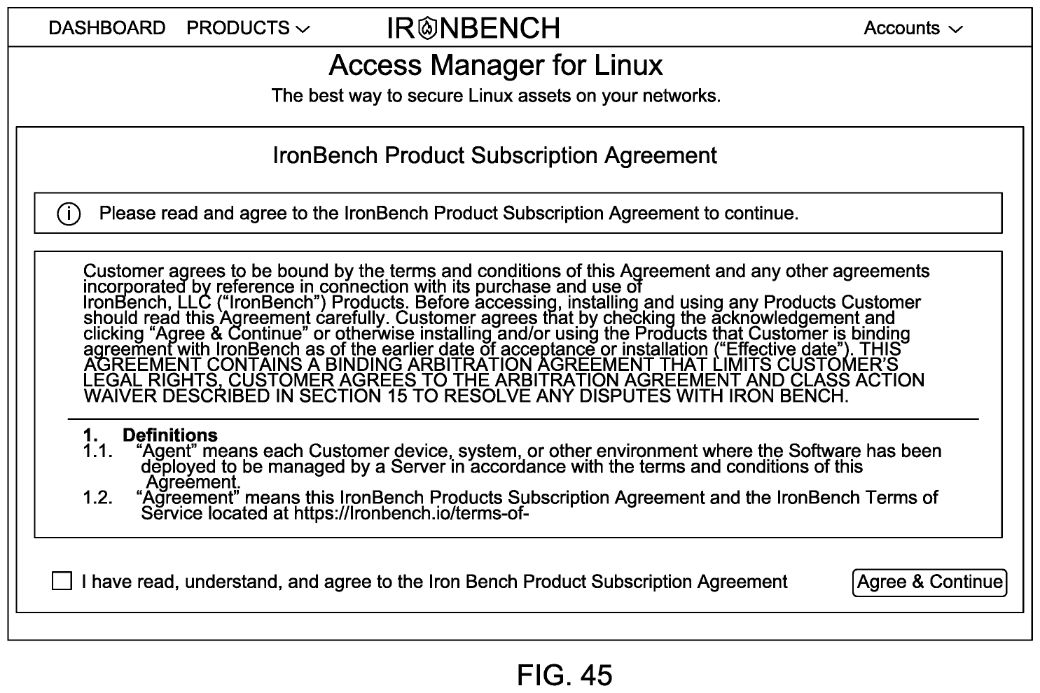

FIG. 45 illustrates an agreement an administrator 20 must agree to prior to using the Access Manager system 10.

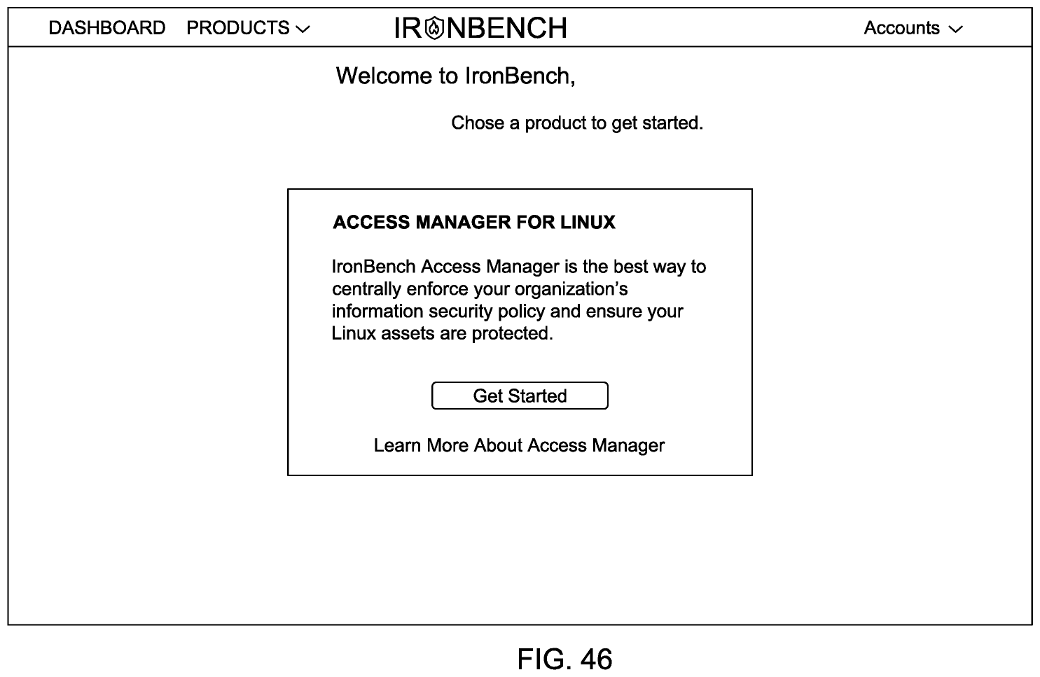

FIG. 46 illustrates another view of the features of the Access Manager Systems 10.

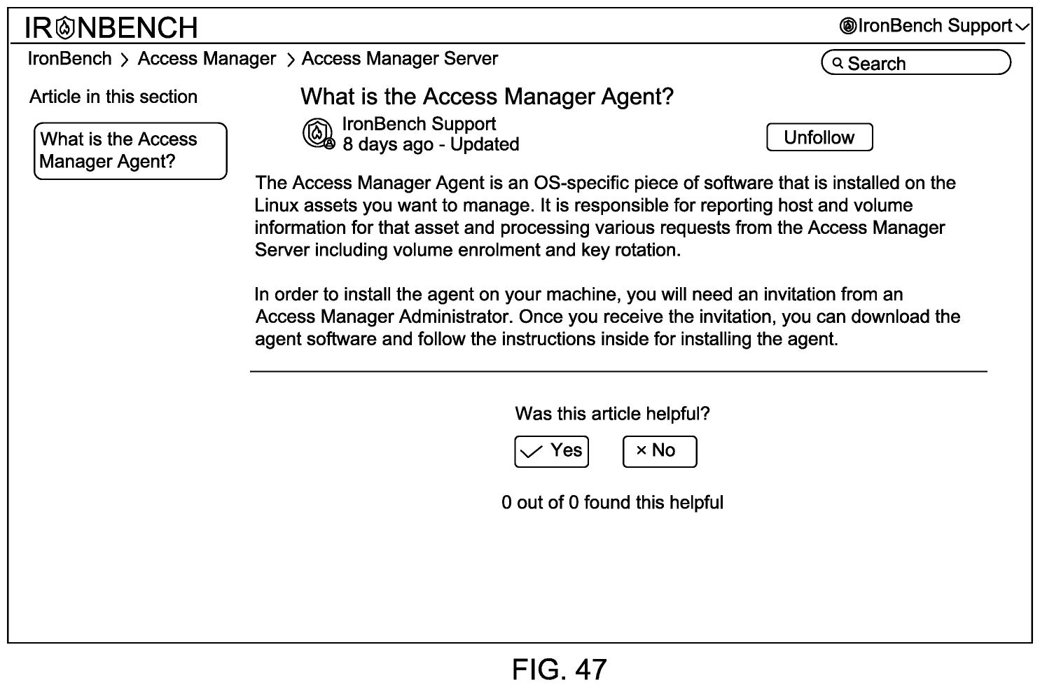

FIG. 47 illustrates a description of the Access Manager System 10.

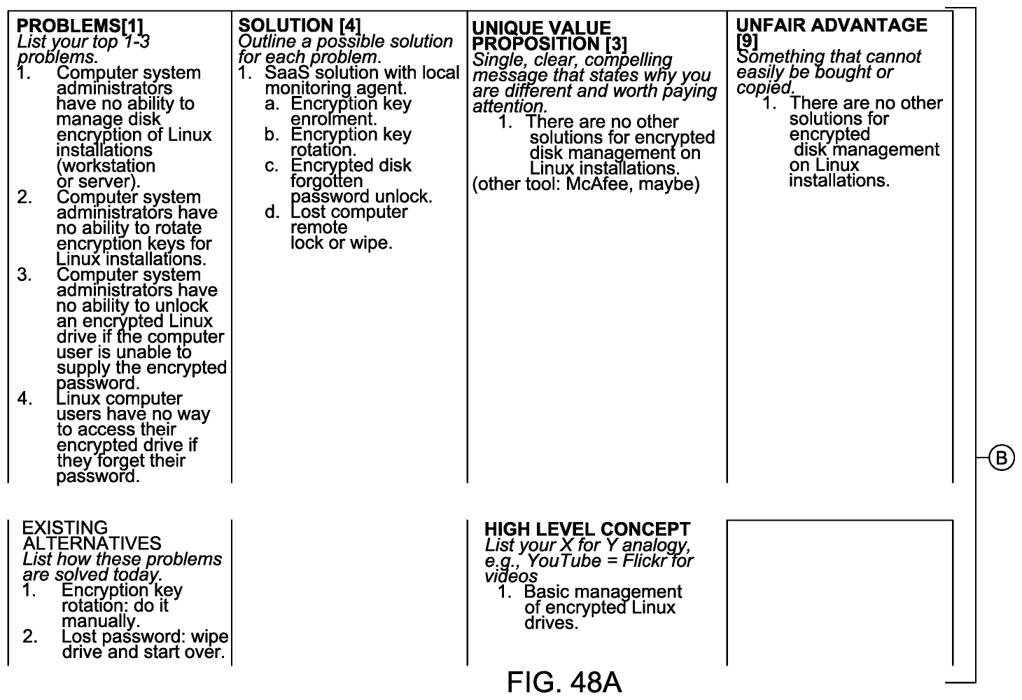

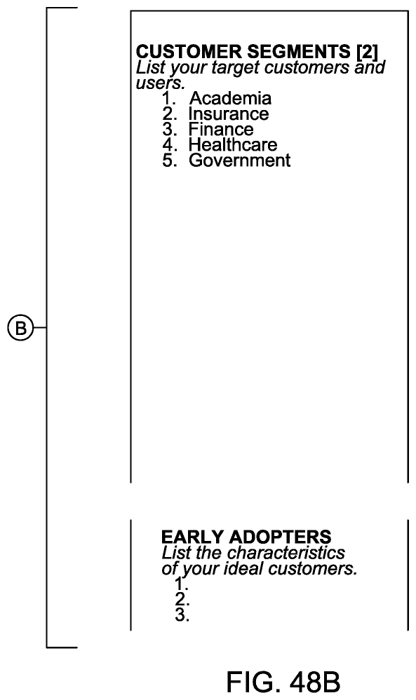

FIG. 48 illustrates an alternative view of the Access Manager System 10.

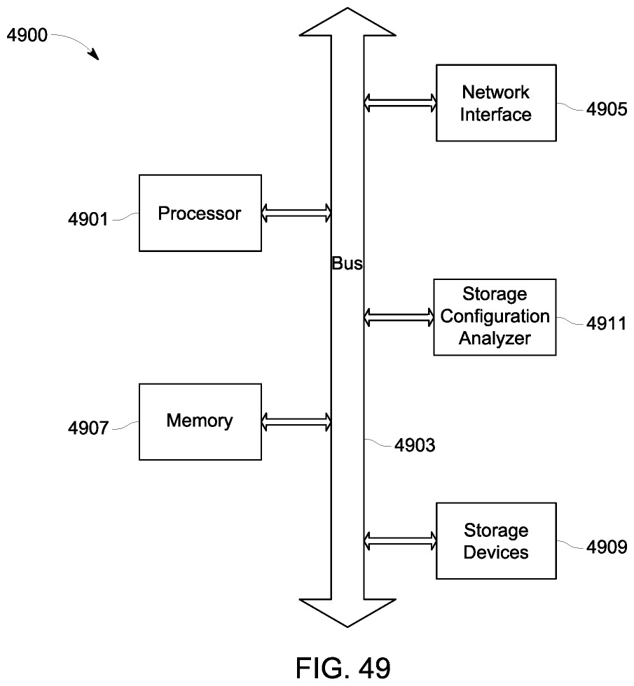

FIG. 49 depicts a computing system 4900 in accordance with an illustrative embodiment. For example, the computing system 4900 may represent a device, such as the server, desktop and laptop computers shown in FIG. 1, tablets, smart displays, kiosks, PDAs, smart phones and any other type of computing device capable of communicating with other computing devices.

The computing system 4900 includes a processor unit 4901 (possibly including multiple processors, multiple cores, multiple nodes, and/or implementing multi-threading, etc.). The computing system includes memory 4907. The memory 4907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media.

The computing system also includes a bus 4903 (e.g., PCI, ISA, PCI-Express, HyperTransport®, InfiniBand®, NuBus, etc.), a network interface 4906 (e.g., an ATM interface, an Ethernet interface, a Frame Relay interface, SONET interface, wireless interface, etc.), and a storage device(s) 4709 (e.g., optical storage, magnetic storage, etc.).

The system memory 4907 embodies functionality to implement embodiments described above. The system memory 4907 may include one or more functionalities facilitating retrieval of the audio information associated with an identifier. Code may be implemented in any of the other devices of the computing system 4900. Any one of these functionalities may be partially (or entirely) implemented in hardware and/or on the processing unit 4901. For example, the functionality may be implemented with an application specific integrated circuit, in logic implemented in the processing unit 4901, in a co-processor on a peripheral device or card, etc. Further, realizations may include fewer or additional components not illustrated in FIG. 49 (e.g., video cards, audio cards, additional network interfaces, peripheral devices, etc.). The processor unit 4901, the storage device(s) 4709, and the network interface 705 are coupled to the bus 4903. Although illustrated as being coupled to the bus 4903, the memory 4907 may be coupled to the processor unit 4901.

The illustrative embodiments provide a system, method and cloud network for managing access to Linux based computers which are part of a group, organization and/or entity. The illustrative embodiments may take the form of an entirely hardware embodiment, an entirely software embodiment (including firmware, resident software, micro-code, etc.) or an embodiment combining software and hardware aspects all generally be referred to herein as a “circuit,” “module” or “system.”

Furthermore, embodiments of the inventive subject matter may take the form of a computer program product embodied in any tangible medium of expression having computer usable program code embodied in the medium. The described embodiments may be provided as a computer program product, or software, including a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or another communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a cloud-based network, local area network (LAN), a personal area network (PAN), or a wide area network (WAN) or the connection may be made to an external computer (e.g., through the Internet using an Internet Service Provider).

The invention is not to be limited to the embodiments described herein. The invention contemplates numerous variations in the Access Manager System. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes or methods of the invention. It is understood that any other modifications, substitutions, and/or additions can be made, which are within the intended spirit and scope of the invention.

What is claimed is:

1. A system for providing access management of Linux-based systems, the system comprising:
at least one administrative server operatively connected to a network;
at least one end-user device operatively connected to the network;
at least one volume associated with the end-user device, the at least one volume being a Linux volume;
agent software executed on each of the at least one end device for operative communication with the administrative server;
wherein the administrative server configured to manage the at least one end-user device or the volume connected to the end-user device; and
wherein the administrative server is configured to remotely access the at least one end-user device or the volume associated with the at least one end-user device.

2. The system of claim 1 wherein each of the at least one volume is an encrypted volume.

3. The system of claim 2 wherein the administrative server is configured to assign at least one encryption key to each of the at least one encrypted volume.

4. The system of claim 3 wherein the administrative server is configured to remotely remove access to the encrypted volume by removing the at least one encryption key.

5. The system of claim 4 wherein the administrative server is configured to remotely view and use the at least one encryption key for access to the encrypted volume.

6. The system of claim 5 wherein the administrative server is configured to report on encryption status of each of the at least one volume.

7. The system of claim 2 wherein the administrative server is configured to assign a plurality of encryption keys to each of the at least one encrypted volume.

8. The system of claim 7 wherein the administrative server is configured to rotate the plurality of encryption keys.

9. A system for providing access management of Linux-based systems:
an administrative server operatively connected to a network;
a plurality of end-user devices operatively connected to the network,
at least one data volume associated with each of the plurality of end-user devices, wherein each of the at least one data volume is a Linux volume;
agent software executed on each of the at least one end device for operative communication with software executing on the administrative service;
wherein the software on the administrative server is configured to manage the at least one end-user device or the at least one data volume connected to the end-user device by
(1) maintaining an audit history by periodically updating encryption status of each of the plurality of end-user devices and the at least one data volume associated with each of the plurality of end-user devices,
(2) in response to a request, triggering a remote deletion of data on one of the at least one data volume associated with one of the plurality of end-user devices,
(3) gaining access to one of the at least one data volume wherein the at least one data volume is encrypted, and a password is forgotten by a user, and
(4) automatically rotate encryption keys for each of the at least one data volume which is encrypted in order to mitigate risk of compromising security.

10. The system of claim 9 wherein the software on the administrative server is further configured to identify each Linux asset operatively connected to the network including each of the plurality of end-user devices.

11. The system of claim 9 wherein each of the at least one data volume is encrypted.

12. The system of claim 11 wherein the software on the administrative server is configured to assign at least one encryption key to each of the at least one data volume.

13. A system for providing access management of Linux-based systems:
an administrative server operatively connected to a network;
a plurality of end-user devices operatively connected to the network,
at least one data volume associated with each of the plurality of end-user devices, wherein each of the at least one data volume is an encrypted Linux volume;
agent software stored on each of the at least one end device for operative communication with software executing on the administrative service;
wherein the administrative server is configured to manage the at least one end-user device or the at least one data volume connected to the end-user device by maintaining an audit history by periodically updating encryption status of each of the plurality of end-user devices and the at least one data volume associated with each of the plurality of end-user devices.

14. The system of claim 13 wherein the administrative server is further configured to remotely delete data on at least one of the at least one data volume.

15. The system of claim 14 wherein the administrative server is further configured to gain access to at least one of the at least one data volume if a user forgets a password.

16. The system of claim 15 wherein the administrative server is further configured to automatically rotate encryption keys for each of the at least one data volume which is encrypted in order to mitigate risk of compromising security.
